(19) United States
(12) Patent Application Publication
(10) Pub. No.: US 2026/0222714 A1
(43) Pub. Date: Jul. 30, 2026

(54) OPTICAL SWITCH

(71) Applicant: HUBER+SUHNER POLATIS LIMITED, Cambridge (GB)

(72) Inventors: David James MONTGOMERY, Cambridge (GB); Peter John WILKINSON, Cambridge (GB)

(73) Assignee: HUBER+SUHNER POLATIS LIMITED, Cambridge (GB)

(21) Appl. No.: 19/148,779

(22) PCT Filed: Dec. 12, 2023
(86) PCT No.: PCT/GB2023/053192

§ 371 Date: Jul. 17, 2025

(30) Foreign Application Priority Data
Jan. 20, 2023 (GB) 2300913.7
Mar. 3, 2023 (GB) 2303202.2

(51) Int. Cl. H04Q 11/00; G02B 6/35

(52) U.S. Cl. CPC H04Q 11/0005; G02B 6/352; G02B 6/3546; G02B 6/356; H04Q 2011/0026

(57) ABSTRACT

An optical switch comprising: multiple input ports, each input port being for transporting an optical signal having at least one component frequency channel; multiple output ports, each output port being for transporting an optical signal having at least one component frequency channel; and a plurality of independently controllable optical groups, each optical group comprising: a first programmable deflection plane for deflecting beams incident on it to form a corresponding first deflected array of beams; a second programmable deflection plane for deflecting beams incident on it to form a corresponding second deflected array of beams; and a beam steering optical element group for transferring the first deflected array of beams between the first programmable deflection plane and the second programmable deflection plane, the beam steering optical element group of each of the plurality of independently controllable optical groups comprising a common remapping plane, wherein: the optical switch is configured to form a Fourier conjugate image for each of the independently controllable optical groups at a respective position on the common remapping plane, the Fourier conjugate image for each of the independently controllable optical groups being a Fourier conjugate image of the beams incident on the first programmable deflection plane of the independently controllable optical group; and the beam steering optical element group of each independently controllable optical group is capable of remapping the Fourier conjugate image for that independently controllable optical group such that the spatial positioning and/or orientation of the Fourier conjugate image for at least one of the independently controllable optical groups is changed differently to the Fourier conjugate image for at least one other of the independently controllable groups.

### BACKGROUND

Optical switches are used in optical telecommunication systems to route optical signals through networks. As optical telecommunications systems have become more popular, the quantity of data carried through the networks has increased, putting greater capacity demands on the switches. It is known to use wavelength division multiplexed (WDM) signals to enable each optical fibre in the network to carry multiple data channels, those data channels separated by unique central frequencies and having non-overlapping bandwidths. Wavelength selective switches (WSSs) are used to route WDM signals through the network.

FIG. 1 illustrates schematically a known M×N WSS 100. The M×N switch comprises N input ports 101 and M output ports 102. Each port carries multiple data channels. A bank of 1×M WSSs 103 splits the multiplexed signal from each input port into its separate frequency channels. The demultiplexed data channels are then directed to the M output ports. A bank of N×1 WSSs 104 at the output combines the data channels into a set of multiplexed signals for output via the output ports 102. In this way, the M×N switch is able to redirect any data channel from an input port to any data channel in an output port, subject to the condition that two channels with overlapping frequencies are not routed to the same output port.

FIG. 2 illustrates schematically a known switch referred to as an add-drop WSS 200. An add-drop WSS 200 is a special type of WSS in which N input ports 201 are connected to K output ports 202, where K>N. A bank of 1×K WSSs 203 splits the multiplexed signal from each input port into its separate frequency channels. The demultiplexed data channels are then directed to K space switches 204. Each space switch 204 can accept data from any of the 1×K WSSs but can only output data from one of the input ports at a time. The output of each space switch 204 is then output from an output port 202, otherwise known as a drop port. Space switches are simpler to implement than N×1 switches, and hence the add-drop WSS of FIG. 2 is preferable to the M×N WSS of FIG. 1. This is particularly the case when K is much bigger than N, and the data density in the K output ports is much lower than in the N input ports.

Both the WSSs of FIGS. 1 and 2 are reversible. For example, edge reconfigurable optical add-drop multiplexers (ROADMs) are used for transferring optical data between core dense wavelength divisional multiplexing (DWDM) and more coarse wavelength division multiplexing (CWDM). An add-drop WSS of the type in FIG. 2 is used in the “dropping” direction (from N input ports to K drop output ports) shown in FIG. 2 to transfer from DWDM to CWDM, and in the reverse “adding” direction (from K drop input ports to N output ports) to transfer from CWDM to DWDM.

FIG. 3 illustrates switch 300 which takes the form of a twin system in a single package formed from two of the N×M add-drop WSSs 200 seen in FIG. 2. In a practical device the two WSSs may be arranged on top of one another (in the steering direction) but for clarity they are shown side-by-side in FIG. 3. The two WSSs in the switch 300 are independent of each other. The components of the WSS 200 are duplicated in the twin system 300. The switch 300 therefore comprises 2×N input ports and 2×M add/drop output ports. The switch 300 also comprises 2×N 1×M WSSs and 2×M space switches.

As shown in FIG. 4, the twin system 300 may be converted to an N degree ROADM 400 by adding connections 401 seen in FIG. 4. The ROADM 400 comprises N input ports, M drop ports, M add ports and N output ports. The switch 300 also comprises 2×N 1×(M+N) WSSs and 2×(M+N) space switches. As illustrated, one WSS operates in a “forward” direction transferring optical signals from N input ports to M drop ports. The other WSS operates in a “backward” direction transferring optical signals from M add ports to N output ports. Connections 401 act as a transit section to transfer signals from N drop ports to N add ports. Specifically, connections 401 act as an N×N switch. Therefore, together, the two WSSs operate so as to transfer optical signals from the N input ports to the N output ports via the transit section formed of N connections.

In passing from the N input ports to the N output ports, signals pass entirely through both WSSs (whereas signals passing to the M drop ports or from the M add ports pass through only one of the WSSs). This path from the N input ports to the N output ports can therefore introduce high optical loss due to the number of times the signals pass through components of the WSSs and the fact that additional optical fibres 401 are used. It would be desirable to construct a ROADM system which induce less loss for signals passing through it.

Furthermore, ROADM systems having the form of a twin system as described above might typically have twice the number of components and twice the volume of a single WSS, neither of which are desirable. It would be desirable to construct a twin (or multiple) N×M system with few additional components over a single N×M system.

### SUMMARY OF THE INVENTION

According to one aspect there is provided an optical switch comprising: multiple input ports, each input port being for transporting an optical signal having at least one component frequency channel; multiple output ports, each output port being for transporting an optical signal having at least one component frequency channel; and a plurality of independently controllable optical groups, each optical group comprising: a first programmable deflection plane for deflecting beams incident on it to form a corresponding first deflected array of beams; a second programmable deflection plane for deflecting beams incident on it to form a corresponding second deflected array of beams; and a beam steering optical element group for transferring the first deflected array of beams between the first programmable deflection plane and the second programmable deflection plane, the beam steering optical element group of each of the plurality of independently controllable optical groups comprising a common remapping plane, wherein: the optical switch is configured to form a Fourier conjugate image for each of the independently controllable optical groups at a respective position on the common remapping plane, the Fourier conjugate image for each of the independently controllable optical groups being a Fourier conjugate image of the beams incident on the first programmable deflection plane of the independently controllable optical group; and the beam steering optical element group of each independently controllable optical group is capable of remapping the Fourier conjugate image for that independently controllable optical group such that the spatial positioning and/or orientation of the Fourier conjugate image for at least one of the independently controllable optical groups is changed differently to the Fourier conjugate image for at least one other of the independently controllable groups.

The optical switch may comprise a remapping optical device located at the common remapping plane, the remapping optical device being common to the beam steering optical element group of each of the independently controllable optical groups.

The remapping optical device may be capable of remapping the first deflected array of beams for each of the independently controllable groups such that the first deflected array of beams for one of the independently controllable optical groups is changed differently to the first deflected array of beams of at least one other of the independently controllable optical groups.

The remapping optical device may be capable of remapping the Fourier conjugate image for each independently controllable group such that the spatial positioning and/or orientation of the Fourier conjugate image for each independently controllable group is changed differently to the Fourier conjugate image for each of the other the independently controllable optical groups.

The remapping optical device may comprise n sets of: a first pair of mirrors configured to provide an optical path for a first set of beams of the first deflected array of beams; and a second pair of mirrors configured to provide an optical path for a second set of beams of the first deflected array of beams, the first and second pairs of mirrors having differently angled surfaces so as to alter the arrangement of the first and second sets of beams of the first deflected array of beams to form a remapped array of beams, where n is the number of the independently controllable optical groups.

The first pair of mirrors may comprise a first mirror and a second mirror and the second pair of mirrors comprises a third mirror and a fourth mirror.

The first mirror and the third mirror may be positioned such that a gap exists between them.

The surface of at least one of the first, second, and third mirrors of a first of the independently controllable optical groups may be angled differently to that of the corresponding mirror of a second of the independently controllable optical groups such that the spatial positioning and/or orientation of the Fourier conjugate image for the first of the independently controllable optical groups is changed differently to the Fourier conjugate image for the second of the independently controllable optical groups. Those surfaces may be respective reflecting surfaces.

The optical switch may comprise a transit optical element group and each of the independently controllable optical groups may be configured such that for a selected independently controllable optical group, the beam steering optical element group of the selected independently controllable optical group is configured to: transfer the first deflected array of beams of the selected optical group from the first programmable deflection plane of the selected group to the transit optical element group; and transfer the first deflected array of beams of another optical group of the plurality of independently controllable optical groups from the transit optical element group to the first programmable deflection plane of the selected group.

The remapping optical device may be configured to, for each independently controllable optical group in the plurality of independently controllable groups, transfer the first deflected array of beams of a first independently controllable group from the first programmable deflection plane of the first group to the transit optical element group, from the transit optical element group to the first programmable deflection plane of a second independently controllable optical group, and transfer the first deflected array of beams of the second independently controllable optical group from the first programmable deflection plane of the second group to the transit optical element group and from the transit optical element group to the first programmable deflection plane of the first group.

The remapping optical device may comprise n sets of: a third pair of mirrors configured to provide an optical path for a third set of beams of the first deflected array of beams, where n is the number of the plurality of independently controllable optical groups and for each group of the independently controllable optical groups, the third pair of mirrors are configured to transfer the third set of beams from the first programmable deflection plane of that group to the transit optical element group.

The optical switch may comprise an optical structure configured to divide the first deflected array of beams of at least of the independently controllable groups into two sets of beams separated by a gap.

The optical switch may be configured such that the second deflected array of beams are directed to the set of output ports through the gap.

The optical structure may comprise: a first mirror assembly configured to divert first and second groups of parallel optical signals incident upon it; and a second mirror assembly configured to realign the first and second groups of diverged optical signals to be parallel to each other and spaced apart by a gap, wherein the first mirror assembly comprises a first mirror for receiving the first group of parallel optical signals and a second mirror for receiving the second group of parallel optical signals, the first mirror and second mirror angled away from each other; and the second mirror assembly comprises a third mirror for receiving the first group of diverged optical signals and a fourth mirror for receiving the second group of diverged optical signals, the third mirror being inverse to the fourth mirror.

The first mirror and the third mirror may be parallel to one another and the second mirror and the fourth mirror may be parallel to one another. In each case the reflecting surfaces of the respective mirrors may be on parallel planes.

The optical structure may be common to two of the independently controllable optical groups and may be configured to divide the first deflected array of beams of each of the two independently controllable optical groups into two sets of beams separated by a gap.

The optical structure is common to each of the independently controllable groups in the plurality independently controllable optical groups and is configured to divide the first deflected array of beams of each of the independently controllable optical group into two sets of beams separated by a gap.

Each independently controllable optical group comprises an optical arrangement comprising a polarising beam splitter, a Faraday rotator and a half wave plate.

The first programmable deflection plane of each independently controllable optical group may be on the same plane as the first programmable deflection plane of the other independently controllable optical groups.

The second programmable deflection plane of each independently controllable optical group may be on the same plane as the second programmable deflection plane of the other independently controllable optical groups.

The common remapping plane may be arranged for remapping beams received from multiple ones of the inputs to a common optical device.

The common optical device may be a gap optic.

The optical switch may be configured to form each of the said Fourier conjugate images at a different position from the others.

Each Fourier conjugate image may be formed in a steering direction of the respective beam.

According to a second aspect there is provided an optical switch comprising: multiple optical input ports; multiple optical output ports; and a switching structure for switching beams received at the inputs to selected ones of the outputs, the switching structure comprising multiple WSSs arranged for receiving beams from the inputs and a remapping optical device common to the multiple WSSs and configured to remap the beams for each WSS such that the beams for at least one of the WSSs is mapped differently to that of another of the WSSs.

That different mapping may comprise remapping a Fourier conjugate image for each WSS such that the spatial positioning and/or orientation of the Fourier conjugate image for at least one of the WSSs is changed differently to the Fourier conjugate image for at least one other of the WSSs.

### BRIEF DESCRIPTION OF THE FIGURES

The present invention will now be described by way of example with reference to the accompanying drawings. In the drawings:

FIG. 1 illustrates a known M×N WSS;

FIG. 2 illustrates a known add-drop WSS;

FIG. 3 illustrates a known twin system formed of two add-drop WSSs;

FIG. 4 illustrates a known ROADM switch;

FIG. 5 illustrates an improved ROADM switch;

FIG. 6 illustrates a twin system formed of two add-drop WSSs;

FIG. 7 illustrates a remapping optical device;

FIG. 8 illustrates two examples of remapping optical devices;

FIG. 9 illustrates the optical elements included in a twin system looking down on the dispersion direction;

FIG. 10 illustrates the optical elements included in a twin system looking down on the steering direction;

FIG. 11 illustrates the spatial layout of the twin system looking down on the dispersion direction;

FIG. 12 illustrates the spatial layout of another twin system looking down on the dispersion direction;

FIG. 13 illustrates a gap optic

FIG. 14 illustrates a gap optic FIG. 15 illustrates the spatial layout of another twin system looking down on the dispersion direction;

FIG. 16 illustrates a ROADM switch;

FIG. 17 illustrates a remapping optical device;

FIG. 18 illustrates the optical elements included in a ROADM switch looking down on the dispersion direction;

FIG. 19 illustrates the optical elements included in a ROADM switch looking down on the steering direction;

FIG. 20 illustrates the spatial layout of the ROADM switch looking down on the dispersion direction;

FIG. 21 illustrates a remapping optical device;

FIG. 22 illustrates the optical elements included in a ROADM switch looking down on the dispersion direction;

FIG. 23 illustrates the optical elements included in a ROADM switch looking down on the steering direction;

FIG. 24 illustrates the spatial layout of the ROADM switch looking down on the dispersion direction;

FIG. 25 illustrates a gap optic; and

FIG. 26 illustrates an optical arrangement.

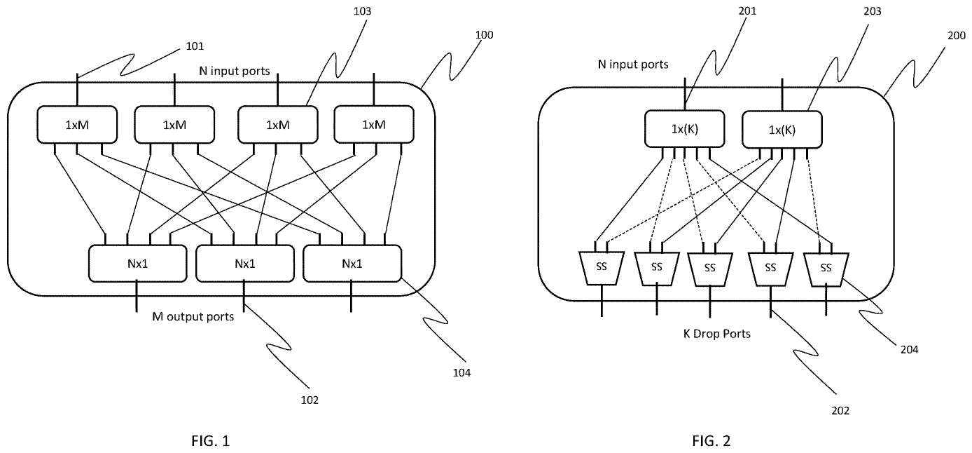

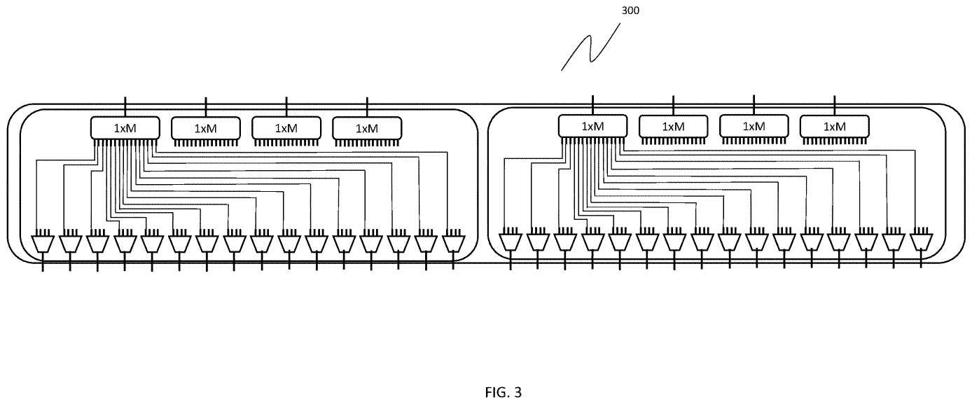

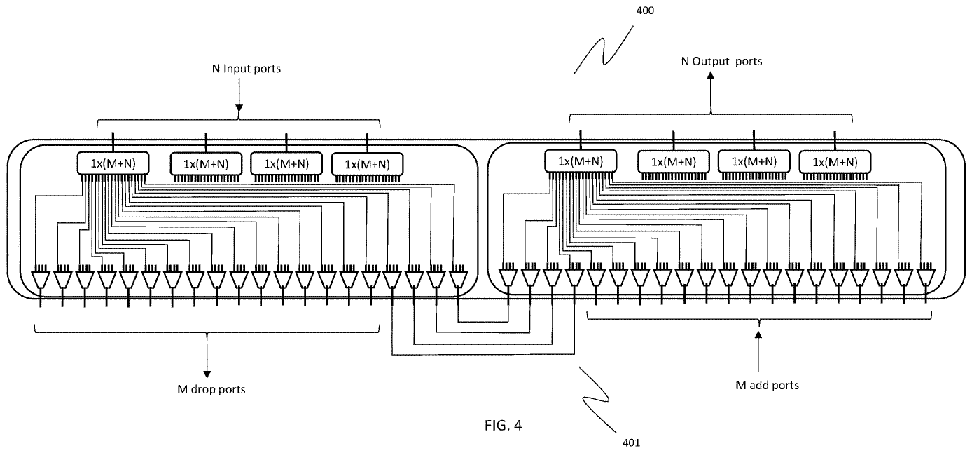

### DETAILED DESCRIPTION

The following describes several exemplary optical switches which utilise two or more programmable deflection planes and a beam steering optical element group to optically route light from a set of input ports to a set of output ports. The described optical switches may be WSSs. These WSSs may be implemented as add-drop WSSs (adWSS), for example for transferring light from core DWDM networks to lower capacity CWDM networks. Alternatively, the described WSSs may be implemented as M×N WSSs. All the examples described herein use optical components to route the light through the switches. There is no absorption and re-emission of light. Thus the optical path from an input to an output might be provided as a purely optical transmission path.

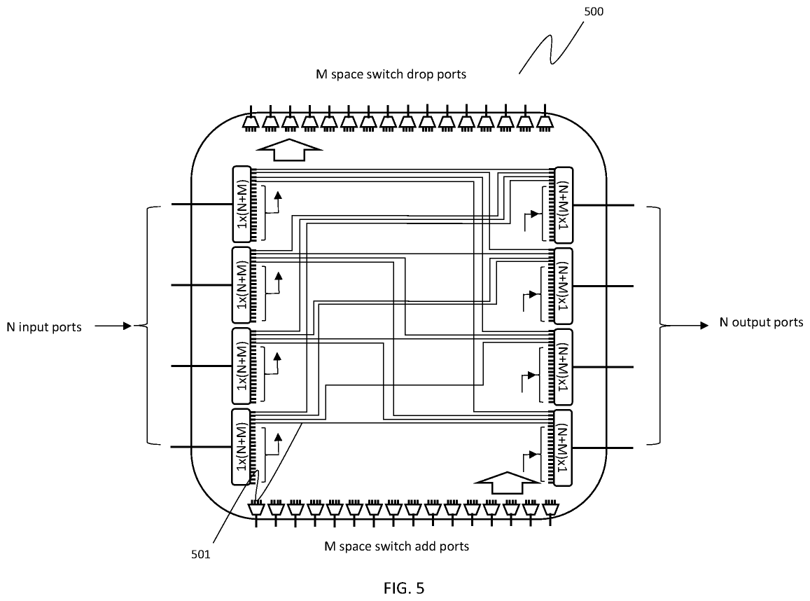

FIG. 5 illustrates an example of a ROADM system 500 in which the N input ports and N output ports are directly connected through specific switching positions, for example at 501. In other words, ROADM 500 features internal connections 501 which operate as an internal transit section. In passing from the N input ports to the N output ports, signals need not pass entirely through both WSSs. Signals therefore pass through fewer optical components and have a shorter optical path between the N input ports and N output ports compared, for example, to the system of FIG. 4. The ROADM system 500 can therefore reduce loss with respect to the ROADM 400 seen in FIG. 4.

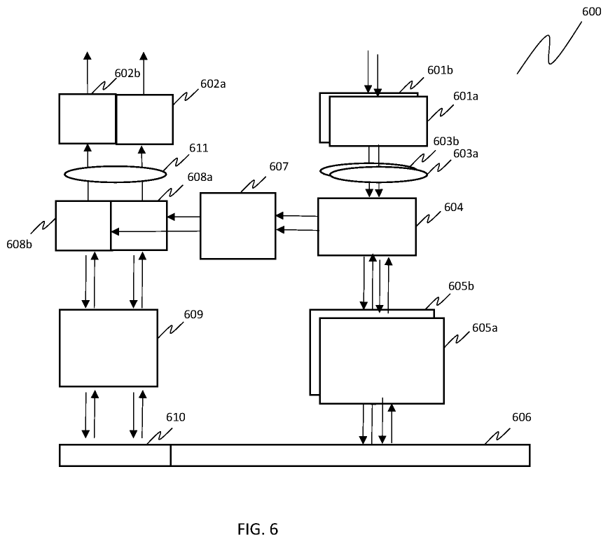

FIG. 6 illustrates a twin system 600 formed of two M×N add-drop WSSs in the same package.

In particular (as explained in more detail below), the two WSSs have programmable deflection planes which have a normal pointing in the same hemisphere. The two WSSs may share a programmable deflection plane for all four switching planes. The WSSs are independent in that it is not possible to switch light between the input and output ports of different WSSs. It is noted that the examples described herein can equally be extended to a system formed of more than two N×M add-drop WSSs.

Previous examples of twin systems formed of two M×N add-drop WSSs comprise two sets of all of the components of one WSS. In contrast, the twin system 600 seen in FIG. 6 comprises components which are common to both WSSs, thereby reducing the overall number of components in the packaged system. The twin system comprises two sets of N input ports 601 (601a, 601b) and two sets of N output ports 602 (602a, 602b). Following the N input ports 601a, the system includes two fan lenses 603a, 603b. The system further includes single remapping optical device 604 which is common to both WSSs. There may be a single remapping optical device 604 serving the entire package and/or serving all the input ports in a single optically interlinked system. The system also includes two optical systems 605a and 605b. Each optical system 605a, 605b is a 4F imaging system. Each optical system comprises two lenses having optical power in the dispersion direction and a demultiplexer located between the two lenses having optical power in the dispersion direction. The demultiplexer is located at the Fourier plane between the two lenses. Each optical system 605a, 605b further includes a lens with optical power in the steering direction located between the two lenses which have optical power in the dispersion direction. In this system, the steering direction is orthogonal to the dispersion direction. The dispersion direction is the direction in which the demultiplexer spreads the channels out on the SLM. The steering axis is orthogonal to both this and the direction the beams are deflected by the SLM. The steering and dispersion direction are also orthogonal to the optical axis. The further lens may be a lens in a Fourier configuration. That is when a lens is located one focal length from a focused input and a focused output plane. Spatial distribution and angular distribution about the optical axis (for small angles) are Fourier conjugate variables. The optical system may comprise three lenses or any odd number of lenses having optical power in the steering direction.

The twin system further includes a first programmable deflection plane 606. The first programmable deflection plane 606 may be divided into multiple portions. The first programmable deflection plane 606 may take the form of a spatial light modulator (SLM) plane. The SLM plane is typically implemented by a liquid crystal on silicon (LCoS) device or optical microelectromechanical system (MEMS). Other light modulators could be used. An LCoS device applies a holographic beam deflection to the spectrum of channels incident on it. The system further includes optical system 607. Optical system 607 comprises a 4F imaging system. The optical system 607 comprises two lenses which have optical power in the dispersion direction. The optical system 607 further includes at least one lens having optical power in the steering direction located between the two lenses having optical power in the dispersion direction. The further lens may be in a Fourier configuration. In a Fourier configuration a lens is located one focal length from a focused input and a focused output plane. Spatial distribution and angular distribution about the optical axis (for small angles) are Fourier conjugate variables. Notably, components 605a/b, 607 and 609 together create an image (inverted or non-inverted) in the dispersion direction, for example by a 4F configuration, and create a Fourier conjugate image in the steering direction. The twin system 600 also includes two optical structures 608a, 608b, each being configured to alter the configuration of the beams incident on it so as to generate a gap between those beams in the steering direction. Each optical structure 608a, 608b may be a gap optic. Each optical structure 608a, 608b may comprise a mirror array positioned such that light beams incident on it are split into a first set of beams and a second set of beams, where the first and second sets of beams exit the structure as two distinct spatially separated groups of beams. In other words, the optical structure 608 splits the incoming light into two portions of light separated by a gap. The first and second sets of beams output from the optical structure 608 are parallel and separated from each other by a gap.

The system 600 further includes optical system 609. Optical system 609 may take the same form as optical system 605 previously described, except for the inclusion of a demultiplexer. For example, optical system 605 may comprise a set of two lenses having optical power in the dispersion direction and at least one lens having optical power in the steering direction positioned between the two lenses having optical power in the dispersion direction. According to another example, optical system 609 may also include a demultiplexer. Furthermore, the system includes a second programmable deflection plane 610. The second programmable deflection plane 610 may be divided into multiple portions. The second programmable deflection plane 610 may take the same form as the first programmable deflection plane 606. The first and second programmable deflection planes 606, 610 may be located on separate SLM devices or may be located on a single common SLM device. Finally, the system includes another fan lens 611.

The path of light beams input from the N input ports 601a, 601b is generally as follows. Input light beams from N input ports 601a pass through fan lens 603a, remapping optical device 604 and optical system 605a before being incident on the first programmable deflection plane 606. The structure of the remapping optical device 604 will be described in more detail below. The fan lens 603a focuses the light input by the input ports 601a through a gap in the remapping optical device 604 towards the optical system 605a. The input light beams then pass through the optical system 605a towards the first programmable deflection plane 606.

Light beams input from the N input ports 601b take an equivalent path through fan lens 603b, remapping optical device 604 and optical system 605b before being incident on a first programmable deflection plane 606.

Each optical system 605a, 605b images the optical signal in the dispersion plane using the two lenses which have optical power in the dispersion direction. The demultiplexer in the optical system spreads and collimates the incoming light in the dispersion plane onto the first programmable deflection plane 606. Specifically, light input from input ports 601a may be incident on the first portion 606a of the first programmable deflection plane 606. Light input from input ports 601b may be incident on the second portion 606b of the first programmable deflection plane. The incoming light therefore forms spectra on the first programmable deflection plane 606. The lens having optical power in the steering direction of optical system 605a, 605b may be in a Fourier configuration with the first programmable deflection plane 606 and the remapping optical device 604 such that the optical system 605 forms a Fourier conjugate in a direction normal to the beam path, along the steering axis. In other words, each optical system 605a, 605b also creates a conjugate Fourier plane in the steering direction. The demultiplexed light incident on the first programmable deflection plane 606 is deflected in the steering direction and passed back through the corresponding optical system 605a, 605b to the remapping optical device 604. Since the demultiplexed light passes back through optical system 605 in the opposite direction, the demultiplexer acts as a multiplexer in the reverse direction. The demultiplexed light incident on the optical system 605 is recombined as it passes back through the optical system. Due to the angular deflection imparted on the light by the first programmable deflection plane 606, once the light has been deflected by the programmable deflection plane 606 and has passed back through optical system 605, as will be explained in more detail below, the deflected multiplexed light is intercepted by one of the mirrors of the remapping optical device 604 such that the light is deflected in a desired direction, for example away from input ports 601.

In the gap optic 608 there may be a pair of mirrors that are parallel to one another (i.e. whose reflecting planes are parallel to each other) and a second pair of mirrors that are parallel to one another. The first pair may be non-parallel to the second pair. In the remapping optic 604 there may be a pair of mirrors that are parallel to one another (i.e. whose reflecting planes are parallel to each other) and a second pair of mirrors that are parallel to one another. The first pair may be non-parallel to the second pair.

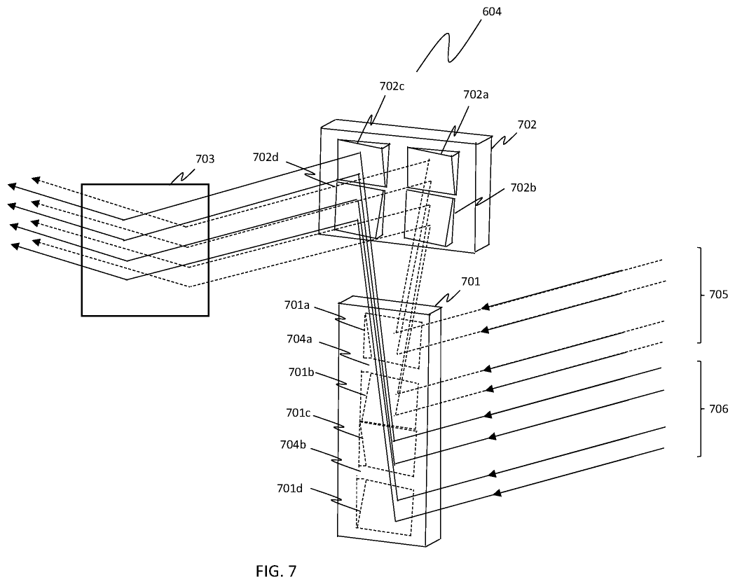

FIG. 7 illustrates an example of remapping optical device 604. The remapping optical device 604 includes a first mirror array 701 at a first mirror plane, a second mirror array 702 at a second mirror plane and a deflection mirror 703. The first mirror array 701 comprises four mirrors 701a, 701b, 701c and 701d. Mirrors 701a, 701b, 701c and 701d of the first mirror array 701 are arranged in a single column. A gap 704a is positioned between mirrors 701a and 701b. A gap 704b is positioned between mirrors 701c and 701d. The gaps are substantially non-reflective. The second mirror array comprises four mirrors 702a, 702b, 702c and 702d. Mirrors 702a, 702b, 702c and 702d of the second mirror array 702 are arranged in a 2×2 grid.

There are two sets of input signals to the twin system 600 via the two sets of N input ports 601a, 601b. Light incident from the input ports 601a, 601b passes through a fan lens 603a, 603b to two spots, one for each group of N input ports. The two spots are aligned with the two gaps 704a, 704b in the remapping optical device 604 such that the light from both sets of input ports passes through undeviated to the first programmable deflection plane 606.

Also explained above, both sets of input signals are incident on the first programmable deflection plane 606. Specifically, the two sets of input signals are incident on two different sets of ports (at the first and second portions 606a, 606b, respectively) at the first programmable deflection plane 606 then pass back through two separate optical systems 605a, 605b towards the remapping optical device 604. FIG. 7 illustrates a first set of incoming beams 705 and a second set of incoming beams 706. The first set of incoming beams 705 are those which originated from input ports 601a (the “top” input ports in FIG. 6) and are incident on the remapping optical device from optical system 605a. The second set of incoming beams 706 are those which originated from input ports 601b (the “bottom” input ports in FIG. 6) and are incident on the remapping optical device from optical system 605b. The first programmable deflection plane 606 deflects the beams incident on it so that their conjugate image back at the remapping optical device 604 is deflected away from the respective gaps 704a, 704b onto mirrors of the first mirror array 701.

The remapping optical device is common to both WSSs in the twin system. The remapping optical device 604 is configured to remap the beams for each WSS such that the beams for at least one of the WSSs is changed differently to that of another of the WSSs. Specifically, the device 604 is configured to remap the Fourier conjugate image for each WSS such that the spatial positioning and/or orientation of the Fourier conjugate image for at least one of the WSSs is changed differently to the Fourier conjugate image for at least one other of the WSSs. In the example seen in FIG. 7, the remapping optical device 604 remaps beams 705 differently from beams 706. The remapping optical device comprises a set of light directors (e.g. mirrors 701, 702) which are located so that beams from multiple input WSSs are incident on them. Light directors receiving light from multiple input WSSs may be located on a common substrate, as illustrated in FIG. 7. The remapping optical device may comprise light directors (e.g. mirrors 701 and/or 702) all located on a first substrate. Each of those light directors may be positioned so as to receive light from a single input WSS, but in combination those light directors may receive light from all the input WSSs. Light directors on a single substrate may be arranged to direct light incident on them from multiple input WSSs to a single or common subsequent device, such as 702 or 703.

FIG. 7 shows that beams 705 which are incident on mirror 701a of the first mirror array are directed to mirror 702a of the second mirror array. Beams 705 which are incident on mirror 701b of the first mirror array are directed to mirror 702b of the second mirror array. The pair of mirrors 701a, 702a therefore provide an optical path for a subset of beams 705 and the pair of mirrors 701b, 702b provide an optical path for a different subset of beams 705. Beams 706 which are incident on mirror 701c of the first mirror array are directed to mirror 702c of the second mirror array. Beams 706 which are incident on mirror 701d of the first mirror array are directed to mirror 702d of the second mirror array. The pair of mirrors 701c, 702c therefore provide an optical path for a subset of beams 706 and the pair of mirrors 701c, 702c provide an optical path for a different subset of beams 706. Each mirror in in a pair may be parallel with respect to the other mirror in the pair. The result of incoming light being incident on pairs of parallel mirror surfaces is that the direction of light entering the beam steering device is the same direction as the light leaving the device and no rotation of the optical image about the optical axis. There is therefore no need for additional optical components in the system to later correct for such rotation. Furthermore, the path length for each chief ray for each port from one plane normal to the optical axis before the first mirror plane to after the second mirror plane is the same for all rays.

Thus, each subset of beams follows a different path through the mirror arrays 701, 702 thereby causing the geometrical distribution of the groups of the beams to change. The single column of incoming light beams is remapped to two columns (i.e. a 2-dimensional array) of light beams. In other words, the four mirrors of the first mirror array 701 positioned above and below each gap deflect the light onto the four mirrors in a 2×2 arrangement of the second mirror array 702 so that light from each group of N input beams corresponds to a column in the plane of the second mirror array. The second mirror array 702 directs beams 705 and 706 to the deflecting mirror 703. The deflecting mirror 703 directs beams 705 to the optical structure 608a. The deflecting mirror 703 directs beams 706 to the optical structure 608b.

With other numbers of beams and WSSs, the array may take other sizes than 2×2. The path of beams after interacting with optical structures 608a, 608b will be explained in more detail below.

According to another example of the remapping optical device 604, the angles of mirrors in the first and second mirror arrays can be chosen so that no gaps are needed in the first mirror plane. According to further examples, there may be more than four mirrors in the first and second mirror arrays and more than two columns may be formed at the second mirror plane. Indeed, any suitable shape or array can be formed such as hexagonal, circular, triangular as well as rectangular.

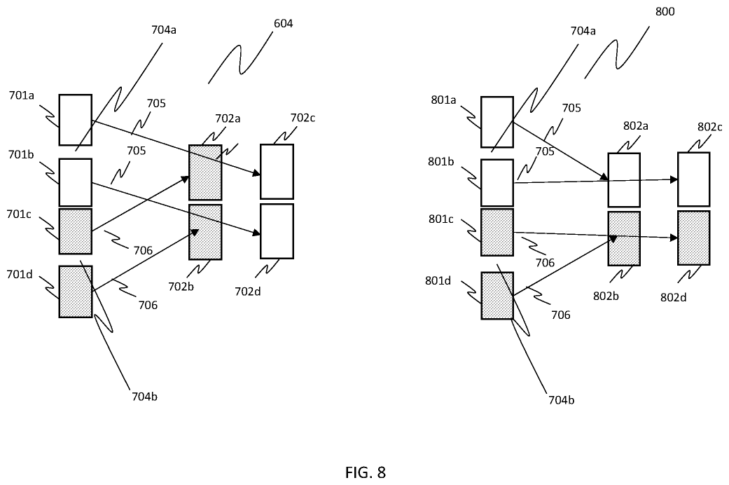

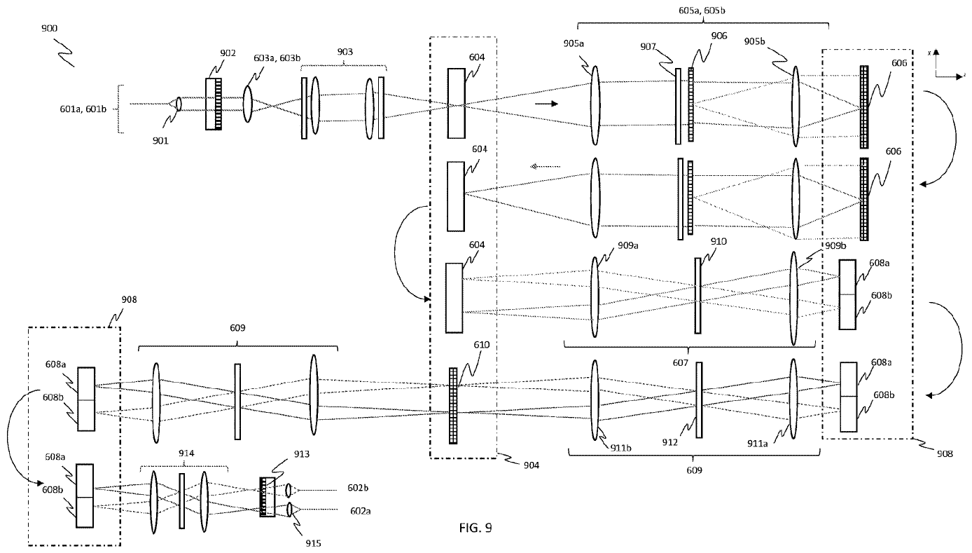

FIG. 8 illustrates a different view of remapping optical device 604 alongside a further example of a remapping optical device 800. This figure illustrates that the angles of mirrors in the first mirror array of the device may be altered such that different pairs of mirrors provide the optical path for the beams 705 and 706. In device 604, beams 705 forming a column incident on the first mirror array 701 are mapped to another column at the second mirror array. Beams 706 forming a column incident on the first mirror array 701 are mapped to another column at the second mirror array positioned next to the column formed of beams 705. Specifically, beams 705 which are incident on mirror 701a of the first mirror array are directed to mirror 702a of the second mirror array. Beams 705 which are incident on mirror 701b of the first mirror array are directed to mirror 702b of the second mirror array. Beams 706 which are incident on mirror 701c of the first mirror array are directed to mirror 702c of the second mirror array. Beams 706 which are incident on mirror 701d of the first mirror array are directed to mirror 702d of the second mirror array.

In the optical device 800, the first mirror array comprises mirrors 801a, 801b, 801c, 801d. The second mirror array comprises mirrors 802a, 802b, 802c, 802d. In device 800, beams 705 forming a column incident on the first mirror array 801 are mapped to a row at the second mirror array. Beams 706 forming a column incident on the first mirror array 801 are mapped to a row at the second mirror array positioned below the row formed of beams 705. Specifically, beams 705 which are incident on mirror 801a of the first mirror array are directed to mirror 802a of the second mirror array. Beams 705 which are incident on mirror 801b of the first mirror array are directed to mirror 802c of the second mirror array. Beams 706 which are incident on mirror 801c of the first mirror array are directed to mirror 802d of the second mirror array. Beams 706 which are incident on mirror 801d of the first mirror array are directed to mirror 802b of the second mirror array. Astigmatic beams may optionally be used.

Light deflected from the deflecting mirror 703 of remapping optical structure 604 is directed through optical system 607 and onto the two optical structures 608a, 608b. The optical system 607 additionally forms a Fourier conjugate in a direction normal to the beam path, along the steering axis. As explained, for the remapping optical device 604 seen in FIG. 7, the deflecting mirror 703 directs beams 705 to the optical structure 608a. The deflecting mirror 703 directs beams 706 to the optical structure 608b. Each optical structure 608a, 608b may take the form of a gap optic configured to alter the configuration of the beams incident on it so as to generate a gap between those beams. Light output by optical structures 608a, 608b is input to optical structure 609 before being incident on the second programmable deflection plane 610. Light deflected by the first programmable deflection plane 606 therefore passes through one of optical systems 605a, 605b, remapping optical device 604, optical system 607, one of optical structures 608a 608b and optical structure 609 before it is incident on the second programmable deflection plane 610.

Due its passing through the multiplexer of optical system 605a, 605b twice, the light incident on the second programmable deflection plane 610 is multiplexed light. The second programmable deflection plane 610 is therefore a space switch plane which includes space switch elements configured to deflect the incident multiplexed light. The second programmable deflection plane 610 angularly deflects the incoming light such that it passes through the gap created in the incoming light by optical structure 1003a/b. The deflected light thus passes through optical system 609 and one of the optical structures 608a, 608b without interfering with oncoming light. The deflected light passes through one of the optical structures 608a, 6-8b undeflected and is distributed to one of the output ports 602a, 602b by fan lens 611.

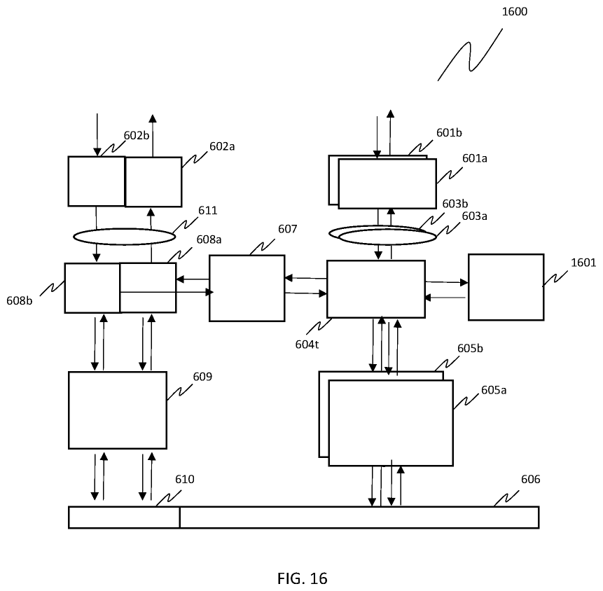

According to other examples, the switch illustrated in FIG. 16 may comprise a further demultiplexer, for example as part of optical structure 609, such that spectra are produced on both the first programmable deflection plane 609 and the second programmable deflection plane 610. The first and second programmable deflection planes 606, 610 may be located on separate SLM devices or may be located on a single common SLM device.

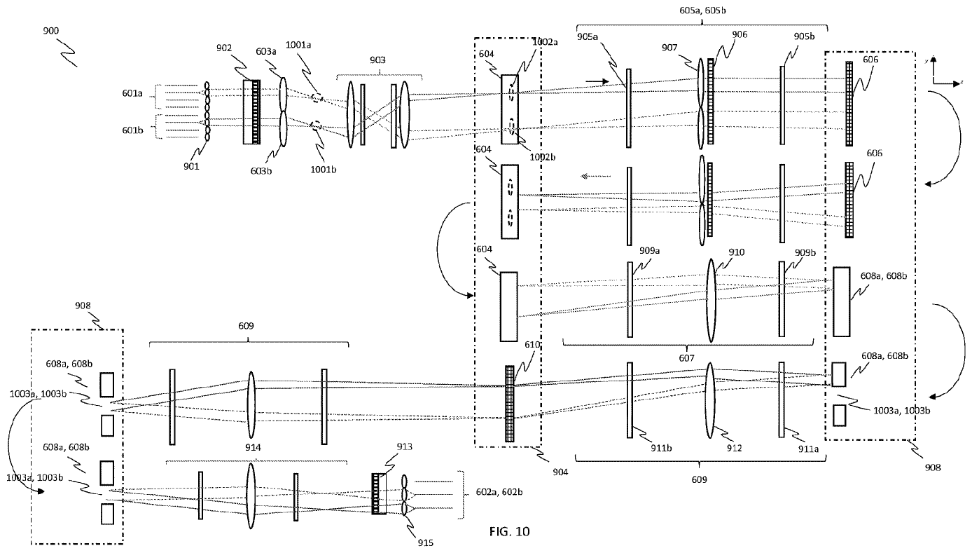

FIG. 9 illustrates the optical elements included in an example twin system 900 looking down on the dispersion direction (i.e. along the steering direction). The dispersion direction may be taken to be the direction in which the demultiplexer spreads the channels out on the SLM. The steering axis may be taken to be orthogonal to both this and the direction the beams are deflected by the SLM. The steering and dispersion direction may both be orthogonal to the optical axis. Elements having the same number as a previously described element are as previously described. FIG. 9 shows the elements arranged to illustrate the order input light passes through them. The same element is shown multiple times if there are multiple passes of that element. As per the twin system shown in FIG. 6, the twin system 900 of FIG. 9 comprises two sets of N input ports 601a, 601b. When viewed along the steering direction as in FIG. 9, these two sets of ports appears as one column of ports. Each port is coupled to a coupling lens 901 and then passes through a polarisation compensation unit 902. The input light passes through one of fan lenses 603a, 603b. After the fan lenses, the light passes through an anamorphic telescope 903, which is known in the art. The input light then passes through gaps 704a and 704b of remapping optical device 604 which is located at space switch plane 904. After passing through the remapping optical device 604 unaffected, the light is incident one of optical systems 605a or 605b. For clarity, FIG. 9 illustrates only one of these systems. In the example seen in FIG. 9, each optical system 605a, 605b is a 4F imaging system. Each optical system comprises two lenses 905a, 905b having optical power in the dispersion direction and a demultiplexer 906 located between the two lenses having optical power in the dispersion direction. The demultiplexer is located at the Fourier plane between the two lenses. Each optical system 605a, 605b further includes a lens 907 with optical power in the steering direction located between the two lenses which have optical power in the dispersion direction. Light is then incident on the first programmable deflection plane 606 at the spectral plane 908. Light deflected by the first programmable deflection plane 606 is deflected back through one of optical systems 605a, 605b towards the remapping optical device 604. The remapping optical device 604 remaps input beams 705, 706 from input ports 601a, 601b from one to two columns, as seen in FIG. 9. The remapped beams are then input to a single optical system 607. In the example shown in FIG. 9, the optical system 607 is a 4F imaging system. The optical system 607 comprises two lenses 909a, 909b having optical power in the dispersion direction. The optical system 607 further includes a lens 910 with optical power in the steering direction located between the two lenses which have optical power in the dispersion direction 909a, 909b. At the spectral plane 908, beams 705 from the first set of N input ports 601a are incident on a gap optic 608a. Beams 706 from the second set of N input ports 601b are incident on a gap optic 608b. The two gap optics 608a, 608b are located side-by-side along the dispersion direction. As described, gap optic 608a generates a gap in beams 705 and gap optic 608b generates a gap in beams 706. Light of both sets of beams then passes through optical system 609 and is incident on the second programmable deflection plane 610 at the space switch plane. In the example shown in FIG. 9, the optical system 609 is a 4F imaging system. The optical system 609 comprises two lenses 911a, 911b having optical power in the dispersion direction. The optical system 607 further includes a lens 912 with optical power in the steering direction located between the two lenses which have optical power in the dispersion direction 911a, 911b. The light is deflected back through optical system 609 towards the gap optics 608a, 608b located at the spectral plane 908. At the gap optics, beams 705 and 706 pass through the respective gaps created in the incident beams by the gap optics and continue on towards the output ports 602a, 602b which are also positioned side-by-side along the dispersion direction. Before reaching the output ports, the beams pass through another anamorphic telescope 914, a polarisation compensation unit 913 and coupling lenses 915.

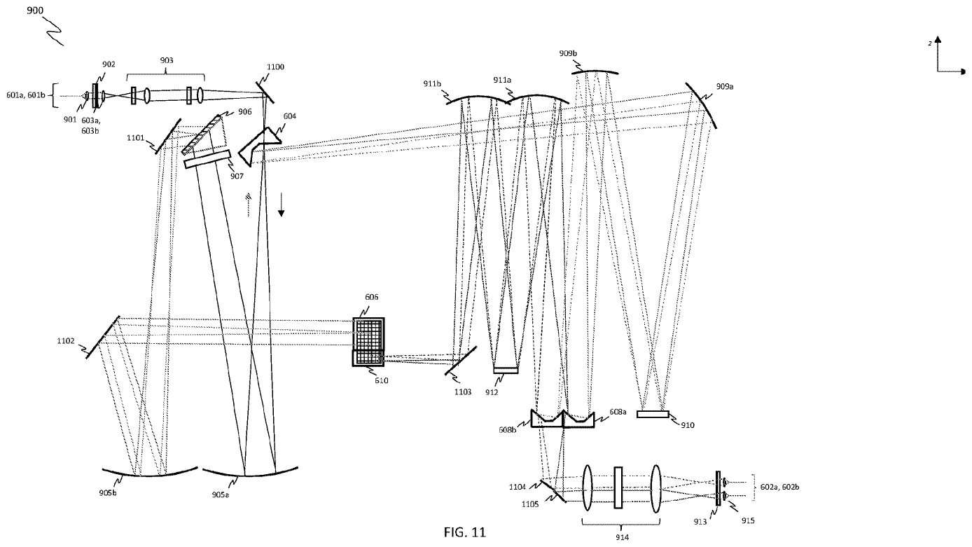

FIG. 10 illustrates the same twin system 900 looking down on the steering direction (i.e. along the dispersion direction). FIG. 10 therefore shows the system in an orthogonal direction to FIG. 9. The components seen in FIG. 9 are therefore also seen in FIG. 10. In addition, since FIG. 10 views the system along the dispersion direction, FIG. 10 illustrates where separate optical components are used for each WSS in the twin system. For example, FIG. 10 shows that light from input ports 601a is focused through fan lens 603a to a circular focus 1001a and is subsequently focused to an anamorphic focus 1002a such that it passes through a gap in the remapping optical device 604. Light from input ports 601b is focused through fan lens 603b to a circular focus 1001b and is subsequently focused to an anamorphic focus 1002b such it passes through a different gap in the remapping optical device 604.

Furthermore, FIG. 10 illustrates that when both sets of beams are incident on the gap optics 608a, 608b (which are positioned side-by-side in the dispersion direction), each gap optic creates a gap between the incoming beams. Specifically, the gap optic 608a creates a gap between 1003a beams of the first subset of beams 705 (from input ports 601a) and the gap optic 608b creates a gap 1003b between beams of the second subset of beams 706 (from input ports 601b). FIG. 10 illustrates that after both sets of beams have been deflected by the second programmable deflection plane 610, they pass through optical system 609 which is common to both sets of beams, and pass through the created gaps 1003a, 1003b on the way to the output ports 602a, 602b.

In FIG. 10, the incident light at the remapping optical device 604 comes from the same input port location of each set of N input ports 601a, 601b (the second port down of each set of ports). The two sets of beams 705, 706 from ports 601a, 601b are arranged above one another at the input ports (top and bottom, along the steering axis). Thus, the two sets of beams after remapping by the remapping optical device 604 have the same height as one another when viewed in the along the dispersion direction as in this diagram. In other words, the two sets of beams are remapped such that are positioned next to one another (side-by-side, along the dispersion axis). When viewed in the dispersion direction, the columns appear coincident on element 608. As this plane is an inverted image of 606, it is a non-inverted image of the input plane 901. Since the column of inputs is at 608 remapped to be in a side-by-side configuration, in the example illustrated in the figures the second input down from each set of inputs will appear coincident from the dispersion direction. Other layouts could be implemented.

FIG. 10 illustrates where the twin system features separate elements for each WSS and where the system features a single element common to both WSSs. As seen in FIG. 6, each WSS includes its own set of N input ports (601a, 601b) and the optical path between the input ports and the remapping optical device 604 includes a fan lens for each WSS (603a, 603b) and an optical system (605a, 605b) for each WSS. In other words, the switch includes a double layer of some optical components. However, after the input beams interact with and are remapped by the mapping optical device 604, which is common to both WSSs, there are no double layers of components due to the remapping of input beams from ports 601a, 601b being above one another (top and bottom, along the steering axis) to being next to one another (side-by-side, along the dispersion axis). The optical path after the remapping optical device 604 therefore includes single optical components which are common to both WSSs or pairs of optical components positioned next to one another (side-by-side, along the dispersion axis). In other words, the use of the common remapping optic 604 which is able to remap the beams for each WSS such that the beams for at least one of the WSSs is changed differently to that of another of the WSSs means that fewer components are needed elsewhere in the system. The light transfer in this design from the remapping optical device 604 involves 4F image transfer in the dispersion direction so this side-by-side arrangement is reproduced at the gap optics 608a, 608b and second programmable deflection plane 610.

FIG. 11 illustrates an example of a spatial layout of the twin system looking down on the dispersion direction (i.e. along the steering direction) and includes the same elements as those described with respect to FIGS. 9 and 10. FIG. 11 shows that the system further includes a number of flat redirecting mirrors 1100, 1101, 1102 and 1103 to direct the input beams between the various optical components in the system. In the example seen in FIG. 11, the first programmable deflection plane 606 is formed on the same SLM device as the second programmable deflection plane 610. The demultiplexer 906 and lens 907 may be arranged in the form of a grism.

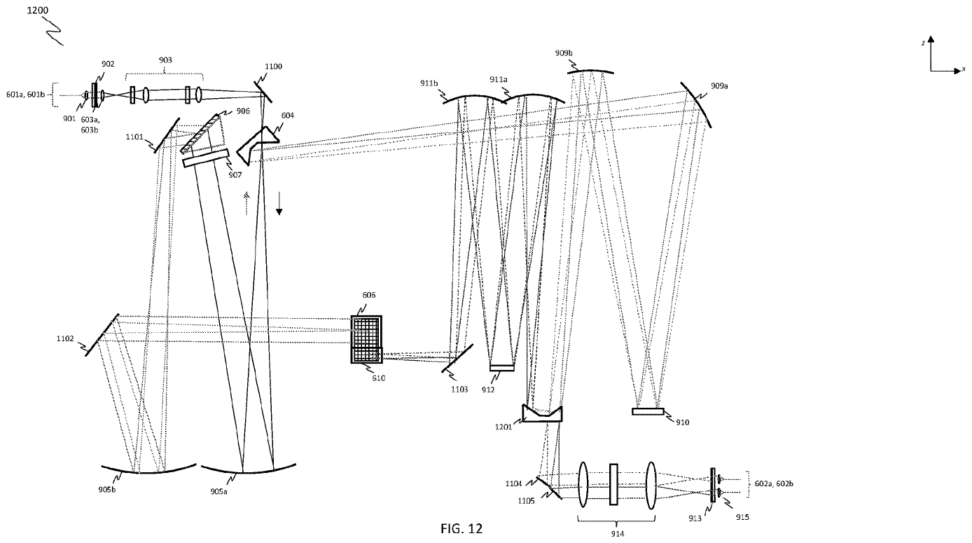

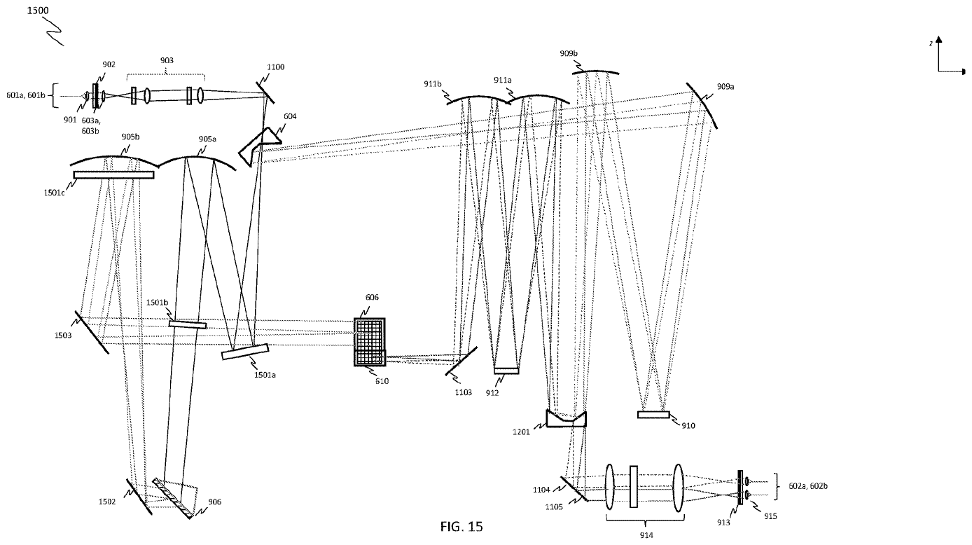

FIG. 12 shows a further example of a twin system 1200. FIG. 12 illustrates the spatial layout of the twin system 1200 looking down on the dispersion direction (i.e. along the steering direction). System 1200 has the same components as twin system 900 previously described, except the two gap optics 608a, 608b positioned side-by-side in twin system 900 are replaced by a single compound gap optic 1201 which is common to both WSSs in the twin system. The single compound gap optic 1201 is described in more detail with respect to FIG. 14.

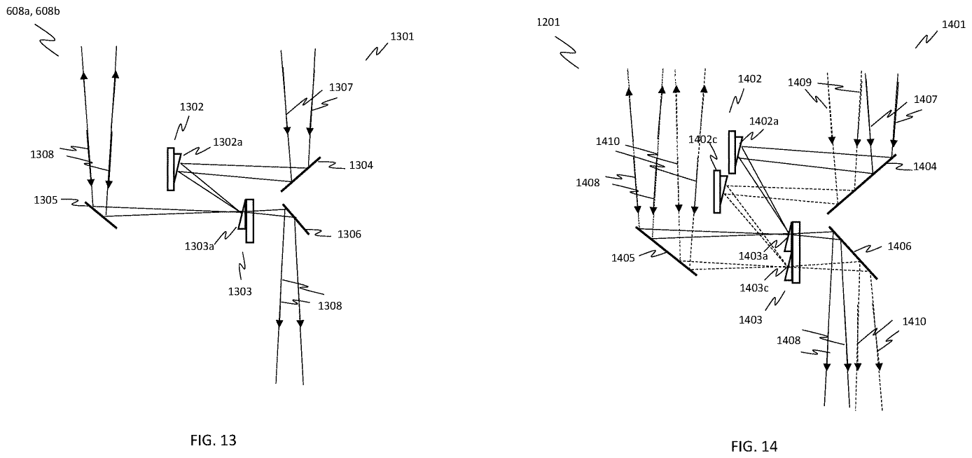

FIG. 13 is a view along the steering direction with flat directing mirrors 1304, 1305 and 1306 to map into one of the gap optics of FIG. 11. FIG. 13 illustrates an optical structure being configured to alter the configuration of the beams incident on it so as to generate a gap between those beams. Each optical structure 608a, 608b has the form seen in FIG. 13. Each optical structure 608a, 608b may be known as a gap optic. Each optical structure 608a, 608b may comprise a mirror array 1301 positioned such that light beams incident on it are split into a first set of beams and a second set of beams, where the first and second sets of beams exit the structure as two distinct spatially separated groups of beams. In other words, each optical structure 608a, 608b splits the incoming light into two portions of light separated by a gap. The first and second sets of beams output from the optical structure 608a, 608b are parallel and separated from each other by a gap.

The mirror array 1301 comprises a first mirror assembly 1302 at a first mirror plane and a second mirror assembly 1303 at a second mirror plane. Each mirror assembly comprises two mirror surfaces displaced with respect to one another along the steering direction. The first mirror assembly 1302 comprises a first mirror surface 1302a and a second mirror surface 1302b. The second mirror assembly 1303 comprises a third mirror surface 1303a and a fourth mirror surface 1303b. The first mirror surface 1302a and the second mirror surface 1302b are displaced relative to one another along the steering axis. The third mirror surface 1303a and the fourth mirror surface 1303b are displaced relative to one another along the steering axis. A gap exists between the third mirror surface 1303a and the fourth mirror surface 1303b along the steering axis. FIG. 13 shows the mirror array 1301 looking down on the dispersion direction (i.e. looking along the steering direction) such that only one of the two mirror surfaces (1302a, 1302b) of each mirror assembly is visible in FIG. 13. The gap optic further includes three flat redirecting mirrors 1304, 1305, 1306.

Optical signals 1307 entering the mirror array 1301, for example from the second programmable deflection plane 610 are incident on the first mirror assembly 1302. A portion of the optical signals (a first group) entering the mirror array are incident on the first directing mirror 1304 and the first mirror surface 1302a. A portion of the optical signal 1307 (the second group) entering the mirror array are incident on the second mirror surface 1302b. The first and second mirror surfaces 1302a, 1302b are angled away from each other. Thus, when parallel optical signals are incident on the first and second mirror surfaces, the first group of optical signals reflected by the first mirror surface 1302a diverge from the second group of optical signals reflected by the second mirror surface 1302b. A gap thereby forms between the divergent first and second groups of optical signals. These non-parallel divergent first and second groups of optical signals are then routed to the second mirror assembly 1303. The light reflected by the first mirror surface 1302a (the first group of optical signals) is directed to the third mirror surface 1303a of the second mirror assembly 1303. The light reflected by the second mirror surface 1302b (the second group of optical signals) is directed to the fourth mirror surface 1303b of the second mirror assembly 1303. Third mirror surface 1303a reflects this first group of optical signals towards directing mirror 1305 out of the mirror array. Fourth mirror 3703b reflects this second group of optical signals towards directing mirror 1305 out of the mirror array in a direction parallel to the first group of optical signals. The third mirror 1303a and fourth mirror 1303b are inverse to each other. The first and second groups of optical signals output from the mirror array 1301 are parallel and separated from each other by a gap. Mirror surfaces 1302a and 1303a may be parallel to one another. The portion of the optical signals incident on the first mirror surface 1302a is therefore parallel to the portion of the optical signal leaving the third mirror surface 1303a. Mirror surfaces 1302b and 1303b may be parallel to one another. The portion of the optical signals incident on the first mirror surface 1302b is therefore parallel to the portion of the optical signal leaving the third mirror surface 1303b. The result of incoming light being incident on pairs of parallel mirror surfaces is that the direction of light entering the beam steering device is the same direction as the light leaving the device and no rotation of the optical image about the optical axis occurs.

FIGS. 9 to 11 illustrate that light deflected by the second programmable deflection plane 610 is directed back towards the gap optics 608a, 608b. FIG. 10 shows that the light passes through a gap in the gap optic and towards the output ports 602a, 602b. FIG. 13 shows specifically that light deflected by the second programmable deflection plane 1308 passes through the gap in the second mirror assembly 1303 between the third mirror surface 1303a and the fourth mirror surface 1303b. Light 1308 is then incident on the redirecting mirror 1306 and is directed towards the output ports 602a, 602b. The twin system 900 employs two gap optics 608a, 608b positioned next to one another in the dispersion direction, where each gap optic receives one of the two columns of beams created by the remapping optical device 604.

FIG. 14 illustrates the structure of the single compound gap optic 1201 used in the twin system 1200 shown in FIG. 12. The gap optic 1201 is used in place of two gap optics 608a, 608b. The gap optic 1201 takes a similar form and operates in the same way as gap optics 608a, 608b. Gap optic 1201 comprises a mirror array 1401. The mirror array 1401 comprises a first mirror assembly 1402 at a first mirror plane and a second mirror assembly 1403 at a second mirror plane. Each mirror assembly comprises four mirror surfaces arranged as two rows of mirror surfaces displaced with respect to one another along the steering direction. The first mirror assembly 1402 comprises a first mirror surface 1402a, a second mirror surface 1402b, a fifth mirror surface 1402c and a sixth mirror surface 1402d. The second mirror assembly 1403 comprises a third mirror surface 1403a, a fourth mirror surface 1403b, a seventh mirror surface 1403c and an eighth mirror surface 1403d. The first mirror surface 1402a and the second mirror surface 1402b are displaced relative to one another along the steering axis. The fifth mirror surface 1402c and the sixth mirror surface 1402d are displaced relative to one another along the steering axis. The third mirror surface 1403a and the fourth mirror surface 1304b are displaced relative to one another along the steering axis. The seventh mirror surface 1403c and the eighth mirror surface 1304d are displaced relative to one another along the steering axis. A gap exists between the third mirror surface 1403a and the fourth mirror surface 1403b along the steering axis. A gap exists between the seventh mirror surface 1403c and the eighth mirror surface 1403d along the steering axis. FIG. 14 shows the mirror array 1401 looking down on the dispersion direction (i.e. looking along the steering direction) such that only two of the four mirror surfaces of each mirror assembly is visible in FIG. 14. The gap optic 1201 further includes three flat redirecting mirrors 1404, 1405, 1406.

FIG. 14 shows that two groups of optical signals 1407, 1409 are incident on the gap optic 1201. These two groups correspond to signals received from both sets of input ports 601a, 602b in FIG. 12. Gap optic 1201 operates in the same way as described with respect to gap optics 608a, 608b seen in FIG. 13 except that two groups of signals 1407, 1409 are incident on the gap optic 1201 and the gap optic is configured to create a gap in between each group of signals separately. Furthermore, once signals 1407, 1409 are deflected by the second programmable deflection plane 610, both sets of signals pass through a gap in the gap optic and towards the output ports 602a, 602b. FIG. 14 shows that deflected signals 1408 pass though the gap in the second mirror assembly 1403 between the third mirror surface 1403a and fourth mirror surface 1403b. Deflected signals 1410 pass through the gap in the second mirror assembly 1403 between the seventh mirror surface 1403c and the eighth mirror surface 1403d.

FIG. 15 illustrates another twin system 1500 which takes the same form as system 1200, except for the optical components located between the remapping optical device 604 and the first programmable deflection plane 606. FIG. 15 illustrates the spatial layout of the system 1500 looking down on the dispersion direction. In the same way as twin system 1200, the optical path between remapping optical device 604 and the first programmable deflection plane 606 of the twin system 1500 comprises two lenses 905a, 905b which each have optical power in the dispersion direction and a demultiplexer 906. In contrast to the arrangement seen in FIGS. 11 and 12 which included only a single lens 907 having optical power in the steering direction, in the twin system 1500, the optical path between the remapping optical device 604 and the first programmable deflection plane 606 includes three optical components having optical power in the steering direction, mirrors 1501a and 1501c and lens 1501b. In other examples, a different odd number and different combination of mirrors and lenses having optical power in the steering direction may be used.

This arrangement has the same effect of producing an image of the Fourier conjugate plane of the first programmable deflection plane 606 at the remapping optical device 604 after deflection, with a position of each beam given by the deflection imparted by first programmable deflection plane. Advantageously, the arrangement of optical components between the remapping optical device 604 and the first programmable deflection plane 606 of twin system 1500 allow for more control over the size of the steering waist at the remapping optical device and reduces the optical height of the system. Lens 1501c has the same focal length as the lens 905b. Thus in a further example, lenses 905b and 1501c may be replaced with a single spherical mirror which can further reduce the number of components in the system.

FIG. 15 shows the system 1500 having a gap optic of the type seen in FIG. 14, the compound gap optic 1201, but according to another example, the system 1500 may include the two gap optics of the type seen in FIG. 13, gap optics 608a, 608b.

A twin system formed of two M×N add-drop WSSs may be converted to an N degree ROADM switch by the addition of a transit section, otherwise referred to as a beam steering optical device. Returning to the example twin system 600 seen in FIG. 6, the twin system may be converted to ROADM 1600 seen in FIG. 16 by the addition of transit section 1601. The transit section 1601 which enables signals to be transferred from one WSS to the other WSS. The transit section can be positioned at any plane that contains a conjugate Fourier image of the spectral plane of any of the programmable deflection planes focused in the steering direction. In the ROADM switch 1600, the transit section 1601 is positioned adjacent to the remapping optical device 604. According to other examples, the transit section 1601 may be located adjacent to the demultiplexer 906 of optical systems 605a, 605b.

In ROADM switch 1600, one WSS operates in a “forward” direction transferring optical signals from N input ports 601a to N drop ports 602a. The other WSS operates in a “backward” direction transferring optical signals from N add ports 602b to N output ports 601b. The transit section enables signals to be transferred from N input ports 601a to N output ports 601b without needing to pass through the entirety of both WSSs. The transit section enables signals to be transferred from the first portion 606a to the second portion 606b of the first programmable deflection plane. The transit section 1601 can act as an N×N switch. According to another example, one WSS operates in a “forward” direction transferring optical signals from N input ports 601b to N drop ports 602b. The other WSS operates in a “backward” direction transferring optical signals from N add ports 602a to N output ports 601a and the transit section enables signals to be transferred from N input ports 601b to N output ports 601a. In this case the transit section enables signals to be transferred from the second portion 606b to the first portion 606a of the first programmable deflection plane 606.

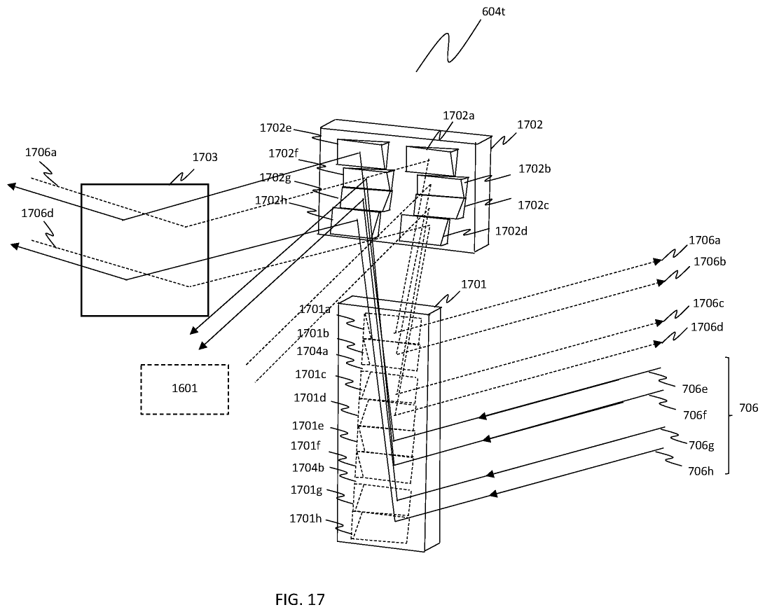

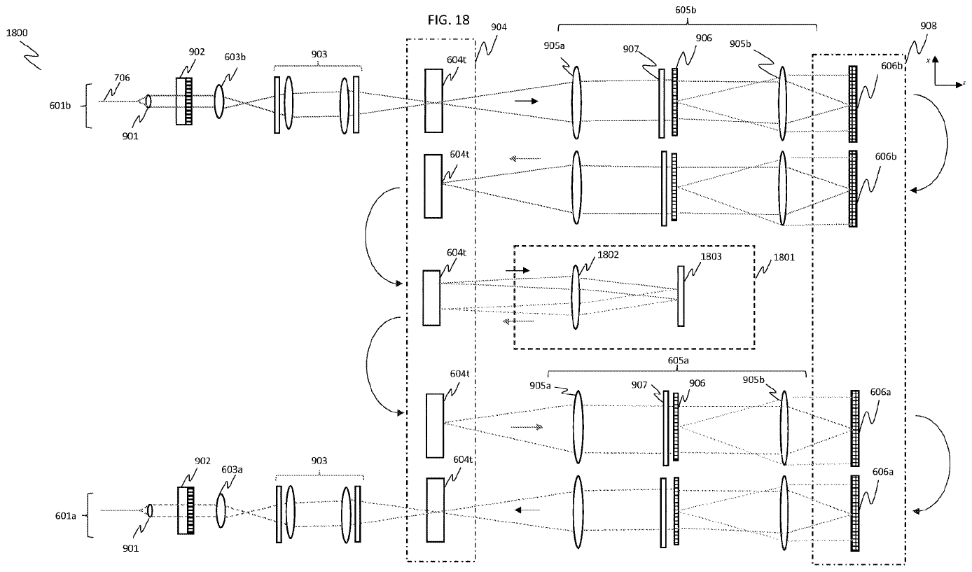

The remapping optical device 604t present in ROADM switch 1600 can be considered a modified version of the remapping optical device 604 seen in FIG. 7. The remapping optical device 604t used in the ROADM switch is shown in detail in FIG. 17 and differs from device 604 in that it comprises an additional four mirrors in the first mirror array 1701 and an additional four mirrors in the second mirror array 1702.

FIG. 17 illustrates the remapping optical device 604t in use for transferring signals 706 from N input ports 601b (the “bottom” input ports) to N output ports 601a (the “top” output ports). The remapping optical device 604t includes a first mirror array 1701 at a first mirror plane, a second mirror array 1702 at a second mirror plane and a deflection mirror 1703. The first mirror array 1701 comprises eight mirrors 1701a, 1701b, 1701c, 1701d, 1701e, 1701f, 1701g and 1701h. Mirrors 1701a, 1701b, 1701c, 1701d, 1701e, 1701f, 1701g and 1701h of the first mirror array 1701 are arranged in a single column. A gap 1704a is positioned between mirrors 1701b and 1701c. A gap 1704b is positioned between mirrors 1701f and 1701g. The second mirror array comprises eight mirrors 1702a, 1702b, 1702c, 1702d, 1702e, 1702f, 1702g and 1702h. Mirrors 1702a, 1702b, 1702c, 1702d, 1702e, 1702f, 1702g and 1702h are arranged in a 4×2 grid i.e. two columns. There is no gap in the columns of mirrors in the second mirror array 1702. The remapping optical device 604t operates in the same manner as previously described with respect to remapping optical device 604 except as described below. In the remapping optic 604t there may be a pair of mirrors that are parallel to one another and a second pair of mirrors that are parallel to one another. The first pair may be non-parallel to the second pair.

FIG. 17 shows that beams 706e which are incident on mirror 1701e of the first mirror array are directed to mirror 1702e of the second mirror array. Beams 706f which are incident on mirror 1701f of the first mirror array are directed to mirror 1702f of the second mirror array. Beams 706g which are incident on mirror 1701g of the first mirror array are directed to mirror 1702g of the second mirror array. Beams 706h which are incident on mirror 1701h of the first mirror array are incident on mirror 1702h of the second mirror array. The second mirror array 702 direct beams 706e, 706h to the deflecting mirror 1703. The deflecting mirror 703 directs beams 706e, 706h to the optical structure 608b via optical system 607.

Similarly, as shown by the dotted lines, beams input at input ports 602a, which pass through optical system 607 and are incident on the remapping optical device 604t are incident on mirrors 1702a and 170d of the second mirror array and directed to mirrors 1701a and 1701d of the first mirror array before being directed to the first programmable deflection plane 606 to be output at “top” output ports 601a.

In addition to the remapping of beams from one to two columns as previously described with respect to device 604, remapping optical device 604t is configured to select some beams which are directed to the transit section 1601. In other words, the remapping optical device 604t includes two separate output paths from the second mirror plane 1702, one to the deflection mirror 1703 to the drop ports 60a and from the add ports 602, and one to and from the transit section 1601.

In the remapping optical device 604t, the mirrors 1702f and 1702g of the second mirror array are transit input ports. The mirrors 1702b and 1702c of the second mirror array are transit output ports. It will be appreciated that when the remapping optical device 604t is used in the opposite direction i.e. for transferring signals 705 from N input ports 601a (the “top” input ports) to N output ports 601b (the “bottom” output ports), the opposite will be true. FIG. 17 illustrates that the beams 706f, 706g which are incident on the transit input ports 1702f, 1702g are directed to the transit section 1601 and not to the deflection mirror 1703.

Similarly, as shown by the dotted lines, beams returning from the transit section 1601 are incident on the transit output ports 1702b, 1702c and are directed to mirrors 1701b, 1701c of the first mirror array. The mirrors 1701b, 1701c direct the signals returned from the transit section to the first programmable deflection plane 606 to be output at “top” output ports 601a. Beams from input ports 602b are therefore merged with beams 706f, 706g which have passed through the transit section (and originated from input ports 601b).

The remapping optical device seen in FIG. 17 comprises two transit input ports 1702f, 1702g and two transit output ports 1702b, 1702c. In other words, the device includes four transit mirrors in the second mirror array 1702f, 1702g, 1702b, 1702c. the device also includes four transit mirrors in the first mirror array 1706f, 1706g, 1701b, 1701c. The remapping optical device 604t thus acts as a 4×4 switch for use with twin systems having sets of 4 input ports and 4 output ports. According to other examples, including those described in more detail below, the device may include more or fewer transit input ports and transit output ports. Generally, for a ROADM having sets of N input ports and N output ports, the remapping optical device acts as an N×N switch having N transit mirrors in the first mirror array 1701 and N transit mirrors in the second mirror array 1702.

For the beams directed to the mirror 1703, the path length for each chief ray for each port from one plane normal to the optical axis before the first mirror plane to after the second mirror plane is the same for all rays. The path length for each chief ray for each port from one plane normal to the optical axis before the first mirror plane to after the second mirror plane is also the same for all of the beams directed to the transit section 1601. However, the path length for beams directed to the mirror 1703 need not be the same as the path length for beams directed to the transit section 1601.

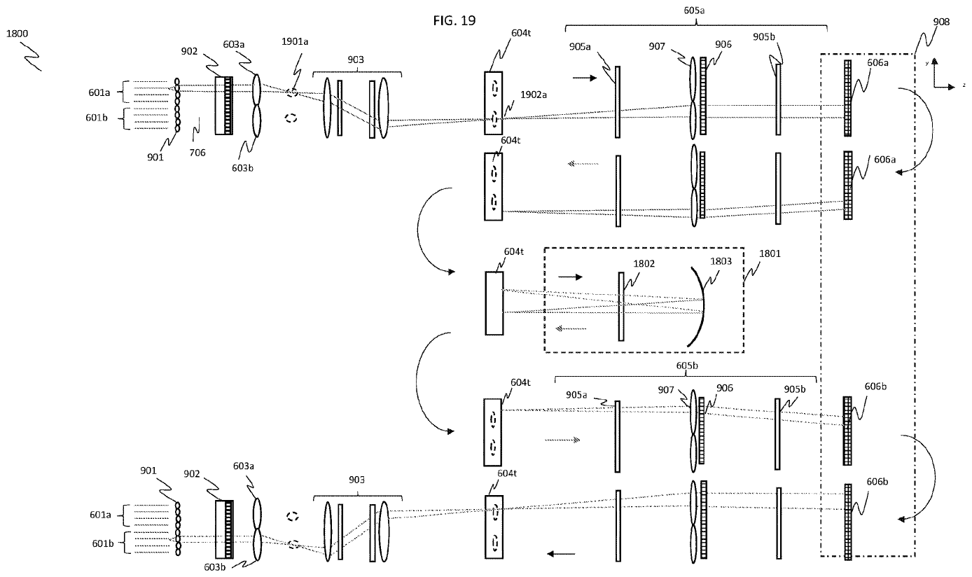

FIG. 18 illustrates ROADM 1800 which has the same form as the ROADM 1600 seen in FIG. 16 and includes the remapping optical device 604t seen in FIG. 17 as well as a transit section 1801. FIG. 18 shows the ROADM 1800 looking down on the dispersion direction (i.e. along the steering direction). Figure illustrates the path between N input ports 601a and N output ports 601b via transit section 1801. In other words, as per FIG. 17, FIG. 18 shows the path of beams from the N “top” input ports 601a to the N “bottom” output ports 601b. FIG. 18 shows the elements in the order input light passes through them. The same element may be shown multiple times if there are multiple passes of that element

As described with respect to the twin system shown in FIG. 9, beams input at ports 601a pass through coupling lens 901 and then pass through a polarisation compensation unit 902. The input light from ports 601a pass through fan lens 603a. After the fan lens, the light passes through an anamorphic telescope 903, which is known in the art. The input light then passes through gap 704b of remapping optical device 604 which is located at space switch plane 904. After passing through the remapping optical device 604 unaffected, the light is incident on+ optical system 605b of the “bottom” WSS. In the example seen in FIG. 18, each optical system 605a, 605b is a 4F imaging system. Each optical system comprises two lenses 905a, 905b having optical power in the dispersion direction and a demultiplexer 906 located between the two lenses having optical power in the dispersion direction. The demultiplexer is located at the Fourier plane between the two lenses. Each optical system 605a, 605b further includes a lens 907 with optical power in the steering direction located between the two lenses which have optical power in the dispersion direction so as produce a Fourier conjugate image in the steering direction at the first programmable deflection plane 606. Light is incident on the second portion 606b of the first programmable deflection plane 606 at the spectral plane 908. Light deflected by the first programmable deflection plane 606 is deflected back through one of optical system 605b towards the remapping optical device 604t.

The remapping optical device 604t is configured to remap input beams 705, 706 from input ports 601a, 601b from one to two columns, as seen in FIG. 9. The remapping optical device 604t therefore remaps some of beams 706 from input ports 601a into one of these columns (not shown). As described with respect to FIG. 18, some of beams 706 are selected by the transit input ports of the remapping optical device 604t to be directed to the transit section 1801.

The transit section 1801 structure seen in FIG. 18 includes a cylindrical lens having power in the dispersion direction 1802 and a cylindrical mirror having power in the steering direction 1803. The steering cylindrical mirror 1803 images the beams incident on the transit input ports of the remapping optical device 604t to the transit output ports of the remapping optical device 604t by a Fourier conjugation. The focal length of the mirror 1803 is chosen so that equal steering waits are obtained. In order to do this, the focal length of the transit steering cylindrical mirror must be equal to:

$$\frac{π {W}^{2}}{λ}$$

where W is the Gaussian waist in the steering direction at the focus in the remapping optical device 604t and λ is the mean wavelength of the light. The dispersion lens 1802 that the light passes twice through as a 4F image of the dispersion waist has a focal length half that of the steering mirror 1803.

The column of transit input ports and the column of transit output ports of the remapping optical device 604t are located on opposite sides in the dispersion direction of the central optical axis of the lenses 1802 and 1803 of the transit section 1801. This arrangement ensures that one column is imaged on the return to the other column.

The beams 706 which are selected by the transit input ports of the remapping optical device 604t therefore pass through lens 1802, are reflected by mirror 1803 and pass back through lens 1802 before they are incident again on the remapping optical device 604t. The beams are incident on the transit output ports and are directed to the optical system 605a of the “top” WSS. The optical system 605a demultiplexes the light and creates a Fourier conjugate image in the steering direction at the first programmable deflection plane 606. Specifically, the light is incident on the first portion 606a of the first programmable deflection plane and is deflected back through optical system 605a. The light passes through gap 704a in the remapping optical device 604t. The beams pass through another anamorphic telescope 903, a polarisation compensation unit 902 and coupling lenses 901 before being output at output ports 601b.

FIG. 19 illustrates the same ROADM 1800 looking down on the steering direction (i.e. along the dispersion direction). FIG. 19 therefore shows the system in an orthogonal direction to FIG. 18. The components seen in FIG. 18 are therefore also seen in FIG. 19. In addition, since FIG. 19 views the system along the dispersion direction, FIG. 19 illustrates where separate optical components are used for each WSS in the twin system. For example, FIG. 19 shows that light from input ports 601a is focused through fan lens 603a to a circular focus 1901a and is subsequently focused to an anamorphic focus 1902a such that it passes through a gap in the remapping optical device 604t.

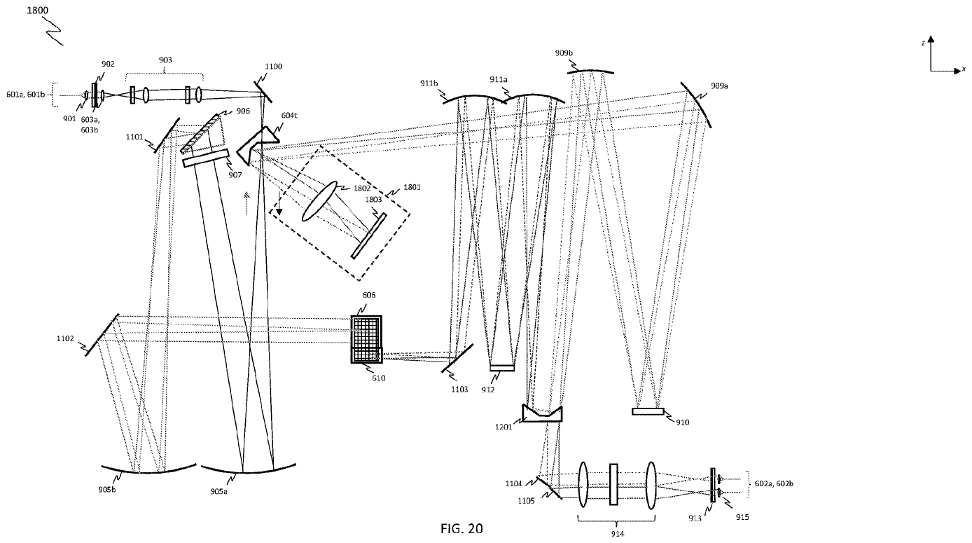

FIG. 20 illustrates an example of a spatial layout of the ROADM 1800 looking down on the dispersion direction (i.e. along the steering direction) and includes the same elements as those described with respect to FIGS. 18 and 19. FIG. 20 shows the same elements as the twin system seen in FIG. 10 with the addition of the remapping optical device 604t and the transit section 1801.

FIG. 20 shows that light passes from the input ports 601a, through the respective fan lens 603b and through the gap in the remapping optical device 604t. The light passes through the 4F arrangement of main cylindrical mirrors 905a, 905b, the respective steering cylindrical lens 907, and the demultiplexer (in this example a grism) arrangement 906 to form demultiplexed spectra on the second portion 606b of the first programmable deflection plane 606. Those channels selected for transit are directed to the transit input ports on the remapping optical device 604t which direct light to the transit section 1801. The light then passes through the transit cylindrical lens 1802, is reflected by the transit steering cylindrical mirror 1803 and is passed back through the transit cylindrical lens 1802 to be focused on the transit output ports at the second mirror plane of the remapping optical device 604t. This light then is passed from the remapping optical device 604t back through main cylindrical mirrors 905a, 905b, the grism 906 and the opposite steering cylindrical lens 907 to the first portion 606a of the first programmable deflection plane 606. The first programmable deflection plane 606 corrects the angle so when the light is again incident on the remapping optical device 604t, it passes through the gap to the respective fan lens 603a, 603b and the transit output ports 601b.

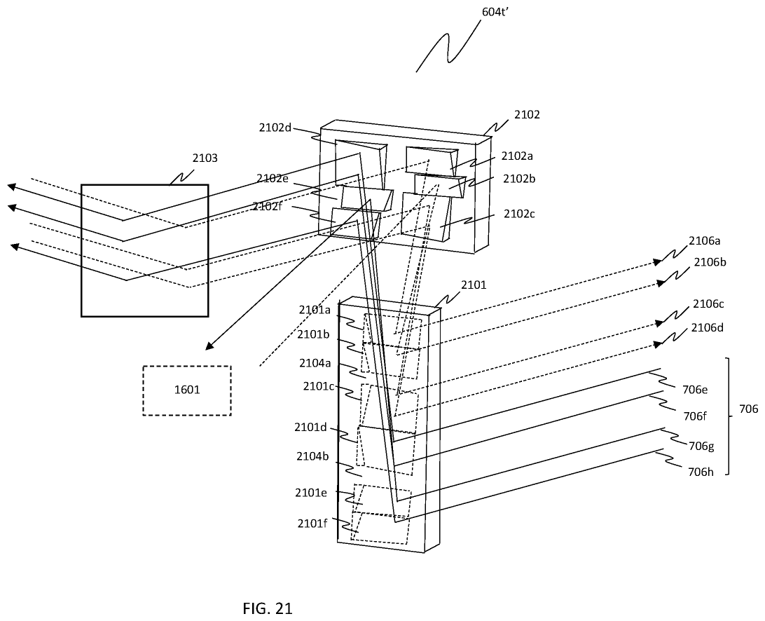

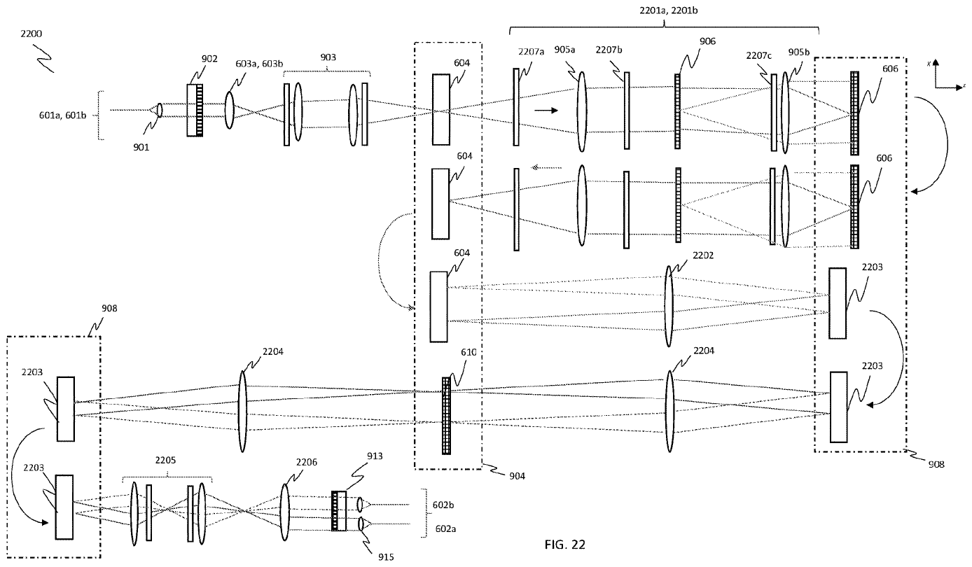

FIG. 21 illustrates a further example of a remapping optical device 604t′ used for transferring signals 706 from N input ports 601a (the “top” input ports) to N output ports 601b (the “bottom” output ports) and for transferring a subset of those signals to the transit section 1601. The remapping optical device 604t′ takes the same form as device 604t previously described and shown in FIG. 17, except that the remapping optical device 604t comprises only one transit input port 2102b and one transit output port 2102e, as described in more detail below.

The remapping optical device 604t′ includes a first mirror array 2101 at a first mirror plane, a second mirror array 2102 at a second mirror plane and a deflection mirror 2103. The first mirror array 2101 comprises six mirrors 2101a, 2101b, 2101c, 2101d, 2101e and 2101f. Mirrors 2101a, 2101b, 2101c, 2101d, 2101e and 2101f of the first mirror array 2101 are arranged in a single column. A gap 2104a is positioned between mirrors 2101b and 2101c. A gap 2104b is positioned between mirrors 2101d and 2101e. The second mirror array 2102 comprises six mirrors 2102a, 2102b, 2102c, 2102d, 2102e and 2102f. Mirrors 2102a, 2102b, 2102c, 2102d, 2102e and 2102f are arranged in a 3×2 grid i.e. two columns. There is no gap in the columns of mirrors in the second mirror array 2102. The remapping optical device 604t′ operates in the same manner as previously described with respect to remapping optical device 604t except as described below.

In the remapping optical device 604t′, mirror 2102e of the second mirror array 2102 is a transit input port. The mirrors 2102b of the second mirror array 2102 is a transit output port. It will be appreciated that when the remapping optical device 604t is used in the opposite direction i.e. for transferring signals 705 from N input ports 601a (the “top” input ports) to N output ports 601b (the “bottom” output ports), the opposite will be true. FIG. 21 illustrates that the beams 706g which are incident on the transit input port 2102e are directed to the transit section 1601 and not to the deflection mirror 2103.

Similarly, as shown by the dotted lines, beams returning from the transit section 1601 are incident on the transit output port 2102b and are directed to mirror 2101b of the first mirror array 2101. The mirror 2101b directs the beams 2106b returned from the transit section to the first programmable deflection plane 606 to be output at “top” output ports 601b. Beams from input ports 602b (2106a, 2106c, 2106d) are therefore merged with beams 2106b which have passed through the transit section (and originated from input ports 601a).

According to the example transit schemes previously described, each transit scheme offers a full N×N switch between each of the N input transit ports and the N output transit ports. In the example seen in FIG. 17, N=4. According to further examples, instead of a single N×N switch, it is possible to use a number P of L×L switches where P=N/L, where N and L are integers. For each L×L switch, only L input transit ports and L output transit ports are used.

The remapping optical device seen in FIG. 21 comprises one transit input port 2101e and one transit output port 2102b. In other words, the device includes two transit mirrors in the second mirror array 2102e, 2102b. The device also includes four transit mirrors in the first mirror array 2101e, 2101b. The device 604t′ thus acts as a 1×1 switch. The beams sent to the transit input port 2102e are received directly by the transit output port 2102b. There is therefore a direct connection between the input and output transit ports without any switching in transit. This reduction in transit input and output ports leads to less switching in transit and reduced loss.

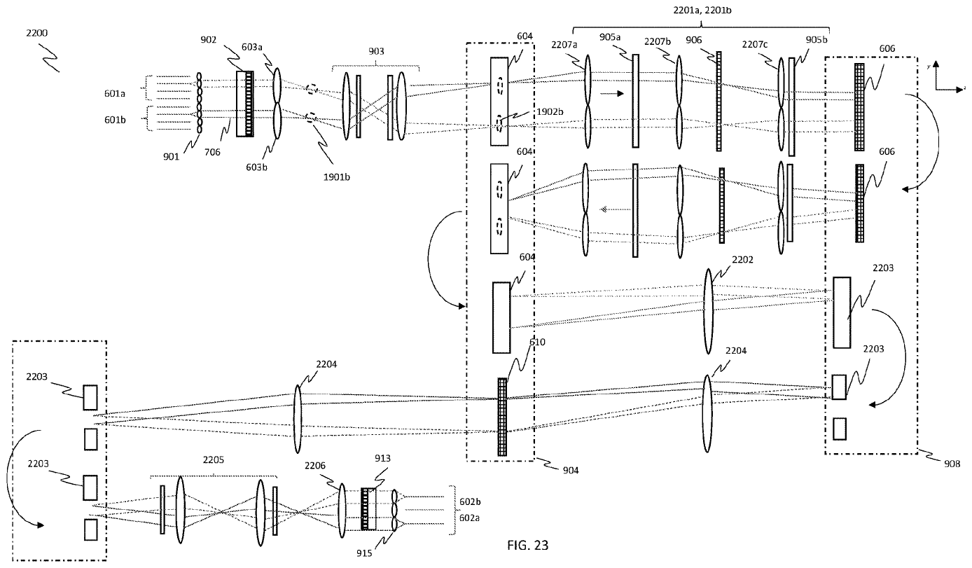

FIG. 22 illustrates a ROADM 2200 looking down on the dispersion direction (i.e. along the steering direction). ROADM 2200 includes many of the same elements as the twin system 900 seen in FIG. 9 and ROADM 1800 seen in FIG. 18. The differences with respect to the previously described examples are as follows.

In place of the optical systems 605a, 605b previously described, the ROADM switch 2200 includes optical systems 2201a, 2201b. Each optical system 2201a, 2201b takes a form similar to that seen in twin system 1500 shown in FIG. 15. Each optical system 2201a, 2201b comprises two lenses 905a, 905b having optical power in the dispersion direction and a demultiplexer 906 located between the two lenses having optical power in the dispersion direction. The demultiplexer is located at the Fourier plane between the two lenses. In contrast to systems 605a, 605b which each include one lens 907 having optical power in the steering direction, each optical system 2201a, 2201b includes three lenses with optical power in the steering direction 2207a, 2207b, 2207c. In other words, the optical path between the remapping optical device 604 and the first programmable deflection plane 606 includes three optical components having optical power in the steering direction. In other examples, a different odd number and different combination of mirrors and lenses having optical power in the steering direction may be used. Steering lenses 2207a, 2207b, 2207c form a Fourier conjugate plane in the steering direction. The steering lens 2207c may be coincident with dispersion lens 905b between the demultiplexer 906 and the first programmable deflection plane 606. Steering lens 2207b may be coincident with the demultiplexer 906. According to further examples, lenses 2207c and 905b are in the same Fourier conjugate relationship with the plane of the demultiplexer 906 and hence have the same focal length in the steering and dispersion directions. Lenses 2207c and 905b are positioned at the same location and have the same focal length. Thus in the simplest arrangement, lenses 2207c and 905b may be replaced by a single lens having optical power in the dispersion direction and in the steering direction. Lenses 2207c and 905b may be circularly symmetric. Lenses 2207c and 905b may be a single spherical lens of the same focal length in both directions.

In place of optical system 607 previously described, ROADM switch 2200 includes a single spherical lens 2202. In place of optical system 609 previously described, ROADM switch 2200 includes a single spherical lens 2204.

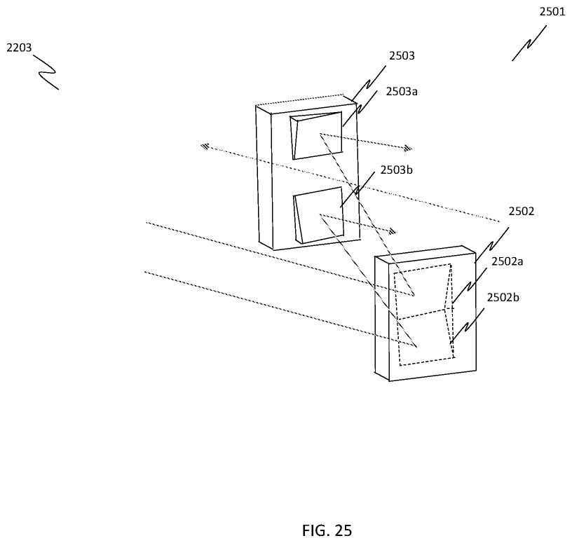

The arrangement shown in FIG. 22 allows a single gap optic 2203 (seen in FIG. 25) to be used instead of two individual gap optics 608a, 608b thereby reducing the component count and layout size of the switch. As shown in FIG. 22, this is achieved by placing the gap optic 2203 in the Fourier conjugate plane of a 4F optical system with spherical lenses 2202, 2204.

The two columns of beams created at the remapping optical device 604 (as previously described) pass through spherical lens 2202 which has optical power in both the steering and dispersion directions. Any of the previously described remapping optics 604, 604t, 604t′ may be used as part of the ROADM 2200. The spherical lens 2202 forms a Fourier conjugate image in both the steering and dispersion directions at the gap optic 2203. In the dispersion direction, the two columns are now coincident and the steering plane is in the same plane as the spectra on the formed on the first programmable deflection plane 606. Thus, only one gap optic 2203 is required to create a gap in the steering direction. The gap optic 2203 is illustrated in more detail in FIG. 25. After exiting the second mirror plane of the gap optic, the light is passed through spherical lens 2204 which creates another Fourier conjugate image such that the light is now incident on the second programmable deflection plane 610 in the correct orientation and in two columns.

The second programmable deflection plane 610 corrects the light angle to pass through the gap in the second mirror plane of the gap optic 2203. In contrast to earlier examples, before reaching the output ports 602a, 602b, the light is passed through a four element anamorphic telescope 2205 and fan lens 2206 which corrects the anamorphic ratio and distributes the light to the output ports 602a, 602b.

FIG. 23 illustrates ROADM switch 2200 looking down on the steering direction (i.e. viewed along the dispersion direction). FIG. 23 illustrates where separate optical components are used for each WSS in the twin system. For example, FIG. 23 shows that light from input ports 601b is focused through fan lens 603b to a circular focus 1001b and is subsequently focused to an anamorphic focus 1002a such that it passes through a gap in the remapping optical device 604.

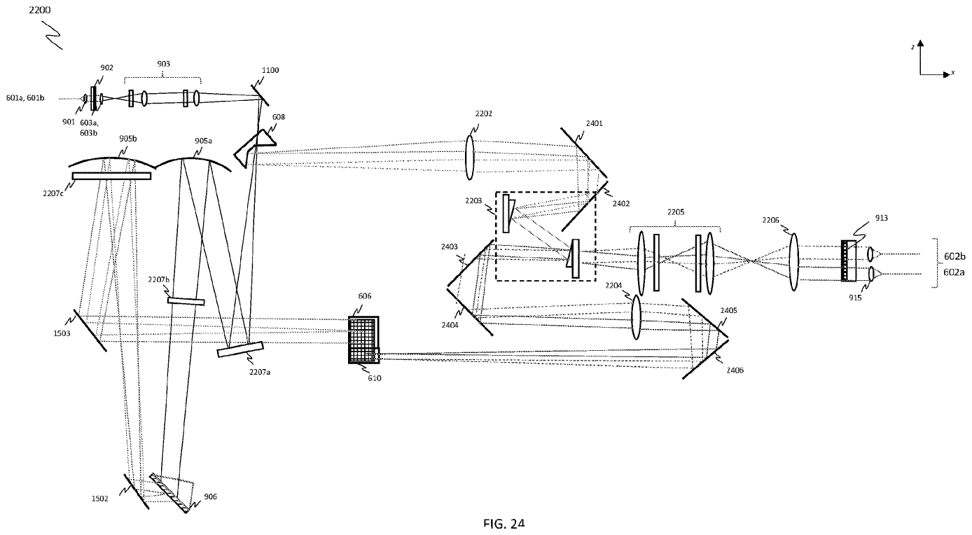

FIG. 24 illustrates an example of a spatial layout of the ROADM switch 2200 looking down on the dispersion direction (i.e. along the steering direction) and includes the same elements as those described with respect to FIGS. 22 and 23. FIG. 24 shows that the system further includes a number of flat redirecting mirrors 1100, 1502, 1503, 2401, 2402, 2403, 2404, 2405 and 2406 to direct the input beams between the various optical components in the system.

The spherical lens 2202 used in ROADM 2200 forms a Fourier conjugate image in both the steering and dispersion directions at the gap optic 2203 such that in the dispersion direction, the two columns of beams created by the remapping optical device 604 are coincident in space. Thus, to create a gap in the steering direction, gap optic 2203 is only required to comprise two mirror surfaces in each mirror array. Gap optic 2203 can therefore have the same structure as gap optics 608a, 608b, one of which is seen in FIG. 13.

FIG. 25 illustrates the gap optic 2203 used in ROADM 2200. As seen in FIGS. 24 and 25, gap optic 2203 is formed of a mirror array 2501 comprising a first mirror assembly 2502 at a first mirror plane and a second mirror assembly 2503 at a second mirror plane. Each mirror assembly comprises two mirror surfaces displaced with respect to one another along the steering direction. The first mirror assembly 2502 comprises a first mirror surface 2502a and a second mirror surface 2502b. The second mirror assembly 2503 comprises a third mirror surface 2503a and a fourth mirror surface 2503b. The first mirror surface 2502a and the second mirror surface 2502b are displaced relative to one another along the steering axis. The third mirror surface 2503a and the fourth mirror surface 2503b are displaced relative to one another along the steering axis. A gap exists between the third mirror surface 2503a and the fourth mirror surface 2503b along the steering axis. FIG. 24 shows the gap optic 2203 looking down on the dispersion direction (i.e. looking along the steering direction) such that only one of the two mirror surfaces of each mirror assembly is visible.

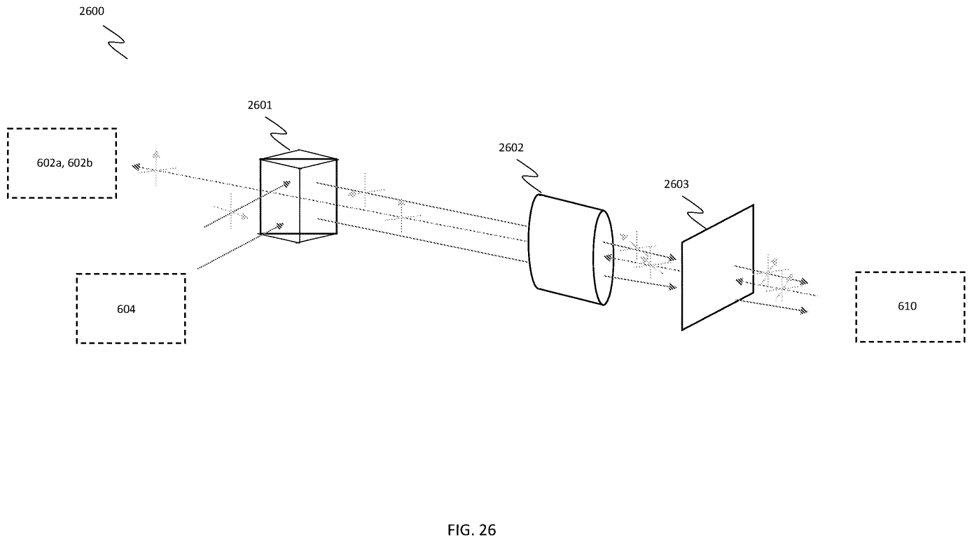

FIG. 26 illustrates an alternative optical arrangement 2600 which can replace the gap optic 2203 in ROADM 2200. The arrangement 2600 may also be duplicated so as to replace gap optics 608a & 608b or gap optic 1201 in any of the previously described systems. The optical arrangement 2600 includes a polarising beam splitter 2601 and a Faraday rotator 2602. The polarising beam splitter is configured to transmit light at a first plane of polarisation and reflect light at a second plane of polarisation which is orthogonal to the first plane of polarisation. The polarising beam splitter 2601 according to this example is configured to transmit light having a vertical plane of polarisation and reflect light having a horizontal plane of polarisation. The optical structure also includes a half wave plate 2603.

In use in ROADM 2200, light from the remapping optical device 604 having a horizontal plane of polarisation passes to the polarising beam splitter 2601 and is reflected. The reflected light from the polarising beam splitter 2601 passes through the Faraday rotator 2602 which rotates the polarisation plane by 45 degrees. The light is then passed to the second programmable deflection plane 610 plane according to the optics seen in FIGS. 22 to 24. A half wave plate 2603 can be placed between the Faraday rotator 2602 and second programmable deflection plane 610 to correct for any polarisation requirement at the second programmable deflection plane.

The light deflected by the second programmable deflection plane 610 is passed back through the optics including the half wave plate 2603 and Faraday rotator 2602 to the polarising beam splitter 2601. The Faraday rotator 2602 rotates the returning light by a further 45 degrees so that it is orthogonal to the incident plane of polarisation at the beam splitter. In other words, the light now has a vertical plane of polarisation so that the light is transmitted by the polarising beam splitter 2601. The light then propagates to the output ports 602a, 602b through the optics seen in FIGS. 22 to 24. According to another example, the optical structure 2600 may be configured in another manner such that the polarising beam splitter transmits light the second programmable deflection plane 610 and reflects light towards the output ports.

The edge ROADM switch described herein incorporates two adWSS or two M×N switches. Each M×N switch is configured to operate so as to transfer signals from ports 601a to 602a, from ports 601b to 602b, from ports 602a to ports 601a and from ports 602b to ports 601b. The edge ROADM switch also operates so as to transfer signals from ports 601a to 601b and from ports 601b to ports 601a. It is therefore the case that according to one example, light from input ports 601a which is not selected by the first programmable deflection plane 606 for transit is deflected to the output ports 602a. Light is which is selected for transit by the first programmable deflection plane 606 and passes through the transit section is therefore merged with light coming from ports 602b at the second programmable deflection plane 610 and together is output at ports 601b. Further adWSS or M×N switches could be incorporated into a single switching device. Suitably, the programmable deflection planes described herein are SLM planes. The SLM plane may be a MEMS mirror array. The SLM plane may be an LCoS device. The SLM plane may be provided by a transmissive liquid crystal panel. The SLM plane may be provided by a DLP SLMs or MEMS mirror array. The LCOS device applies a hologram to enable a beam deflection. Alternatively, the SLM plane may be another locally configurable device capable of applying a deflection to a channel from the input.

In the examples described herein, the first and second programmable deflection planes are incorporated onto a single SLM device. This utilises fewer components, reduces control complexity and hence cost compared to if the programmable deflection planes are on separate SLM devices. Alternatively, the programmable deflection planes may be on separate SLM devices.

In the examples described herein, optical components are used to route data through the described switches. There is no absorption and re-emission of light, thereby avoiding the lag associated with transmitting data through electronical switches. The optical components also have lower power consumption than equivalent electronical implementations.

The examples described herein incorporate one or more diffraction grating. However, any demultiplexer which demultiplexes light signals into spatially separated data channels may be used instead of a diffraction grating in any of the examples. Similarly, any multiplexer which multiplexes spatially separated data channels into multiplexed light signals may be used instead of a diffraction grating in any of the examples. Any suitable optical dispersion device may be used as a multiplexer and/or a demultiplexer.

Lenses and other optical components described herein as single structures may be implemented using assemblies having a plurality of components which achieve the same optical effect. Examples of such assemblies are: achromatic doublets, achromatic triplets, Cook doublets, telescopes and microscopes for imaging lenses. The lenses described herein may be implemented using other optics with the same optical power. For example, a curved mirror may be used as a lens. For example, multiple lens elements, mirrors, mirror arrays, catadioptric systems, holographic optical elements or diffractive optical elements may be used as a lens. Separate elements, for example 4F lenses, with the same optical properties can be arranged as separate passes through or from a single physical element.

The examples described herein generally one or more mirrors. The term “mirror” may be used herein to refer to any reflective surface such as a metallic mirror, an interference layer, a total internal reflection surface (as a prism), a polarisation beamsplitter, or a diffractive or holographic surface.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An optical switch comprising:
multiple input ports, each input port configured to transport an optical signal having at least one component frequency channel;
multiple output ports, each output port configured to transport an optical signal having at least one component frequency channel; and
a plurality of independently controllable optical groups, each optical group comprising:
a first programmable deflection plane configured to deflect beams incident on it to form a corresponding first deflected array of beams;
a second programmable deflection plane configured to deflect beams incident on it to form a corresponding second deflected array of beams; and
a beam steering optical element group configured to transfer the first deflected array of beams between the first programmable deflection plane and the second programmable deflection plane, the beam steering optical element group of each of the plurality of independently controllable optical groups comprising a common remapping plane,
wherein:
the optical switch is configured to form a Fourier conjugate image for each of the independently controllable optical groups at a respective position on the common remapping plane, the Fourier conjugate image for each of the independently controllable optical groups being a Fourier conjugate image of the beams incident on the first programmable deflection plane of the independently controllable optical group; and
the beam steering optical element group of each independently controllable optical group is capable of remapping the Fourier conjugate image for that independently controllable optical group such that the spatial positioning and/or orientation of the Fourier conjugate image for at least one of the independently controllable optical groups is changed differently to the Fourier conjugate image for at least one other of the independently controllable groups.

2. The optical switch of claim 1, wherein the optical switch comprises a remapping optical device located at the common remapping plane, the remapping optical device being common to the beam steering optical element group of each of the independently controllable optical groups.

3. The optical switch of claim 1, wherein the remapping optical device is capable of remapping the first deflected array of beams for each of the independently controllable groups such that the first deflected array of beams for one of the independently controllable optical groups is changed differently to the first deflected array of beams of at least one other of the independently controllable optical groups.

4. The optical switch of claim 1, wherein the remapping optical device is capable of remapping the Fourier conjugate image for each independently controllable group such that the spatial positioning and/or orientation of the Fourier conjugate image for each independently controllable group is changed differently to the Fourier conjugate image for each of the other the independently controllable optical groups.

5. The optical switch of claim 2, wherein the remapping optical device comprises n sets of:
a first pair of mirrors configured to provide an optical path for a first set of beams of the first deflected array of beams; and
a second pair of mirrors configured to provide an optical path for a second set of beams of the first deflected array of beams, the first and second pairs of mirrors having differently angled surfaces so as to alter the arrangement of the first and second sets of beams of the first deflected array of beams to form a remapped array of beams,
where n is the number of the independently controllable optical groups.

6. The optical switch of claim 5, wherein the first pair of mirrors comprises a first mirror and a second mirror and the second pair of mirrors comprises a third mirror and a fourth mirror, and wherein the first mirror and the third mirror are positioned such that a gap exists between them.

7. (canceled)

8. The optical switch of claim 6, wherein the surface of at least one of the first, second, and third mirrors of a first of the independently controllable optical groups is angled differently to the corresponding mirror of a second of the independently controllable optical groups such that the spatial positioning and/or orientation of the Fourier conjugate image for the first of the independently controllable optical groups is changed differently to the Fourier conjugate image for the second of the independently controllable optical groups.

9. The optical switch of claim 1, wherein the optical switch comprises a transit optical element group and wherein each of the independently controllable optical groups is configured such that for a selected independently controllable optical group, the beam steering optical element group of the selected independently controllable optical group is configured to:
transfer the first deflected array of beams of the selected optical group from the first programmable deflection plane of the selected group to the transit optical element group; and
transfer the first deflected array of beams of another optical group of the plurality of independently controllable optical groups from the transit optical element group to the first programmable deflection plane of the selected group.

10. The optical switch of claim 9, wherein the remapping optical device is configured to, for each independently controllable optical group in the plurality of independently controllable groups, transfer the first deflected array of beams of a first independently controllable group from the first programmable deflection plane of the first group to the transit optical element group, from the transit optical element group to the first programmable deflection plane of a second independently controllable optical group, and transfer the first deflected array of beams of the second independently controllable optical group from the first programmable deflection plane of the second group to the transit optical element group and from the transit optical element group to the first programmable deflection plane of the first group.

11. The optical switch as claimed in claim 5, wherein the remapping optical device further comprises n sets of:
a third pair of mirrors configured to provide an optical path for a third set of beams of the first deflected array of beams,
where n is the number of the plurality of independently controllable optical groups and for each group of the independently controllable optical groups, the third pair of mirrors are configured to transfer the third set of beams from the first programmable deflection plane of that group to the transit optical element group.

12. The optical switch of claim 1, wherein the optical switch comprises an optical structure configured to divide the first deflected array of beams of at least of the independently controllable groups into two sets of beams separated by a gap; and wherein the optical switch is configured such that the second deflected array of beams is directed to the set of output ports through the gap.

13. (canceled)

14. The optical switch of claim 12, wherein the optical structure comprises:
a first mirror assembly configured to divert first and second groups of parallel optical signals incident upon it; and
a second mirror assembly configured to realign the first and second groups of diverged optical signals to be parallel to each other and spaced apart by a gap,
wherein the first mirror assembly comprises a first mirror configured to receive the first group of parallel optical signals and a second mirror configured to receive the second group of parallel optical signals, the first mirror and second mirror angled away from each other; and the second mirror assembly comprises a third mirror configured to receive the first group of diverged optical signals and a fourth mirror configured to receive the second group of diverged optical signals, the third mirror being inverse to the fourth mirror.

15. The optical switch of claim 14, wherein the first mirror and the third mirror are parallel to one another and the second mirror and the fourth mirror are parallel to one another.

16. (canceled)

17. The optical switch of claim 12, wherein the optical structure is common to each of the independently controllable groups in the plurality independently controllable optical groups and is configured to divide the first deflected array of beams of each of the independently controllable optical group into two sets of beams separated by a gap.

18. The optical switch of claim 1, wherein each independently controllable optical group comprises an optical arrangement comprising a polarising beam splitter, a Faraday rotator and a half wave plate.

19. The optical switch of claim 1, wherein the first programmable deflection plane of each independently controllable optical group is on the same plane as the first programmable deflection plane of the other independently controllable optical groups, and the second programmable deflection plane of each independently controllable optical group is on the same plane as the second programmable deflection plane of the other independently controllable optical groups.

20. (canceled)

21. The optical switch of claim 1, wherein the common remapping plane is configured to remap beams received from multiple ones of the inputs to a common optical device.

22. The optical switch of claim 21, wherein the common optical device is a gap optic.

23. The optical switch of claim 1, the optical switch being configured to form each of the said Fourier conjugate images at a different position from the others.

24. The optical switch of claim 1, wherein each Fourier conjugate image is formed in a steering direction of the respective beam.
